(19) United States
(12) Patent Application Publication
(10) Pub. No.: US 2010/0103563 A1
(43) Pub. Date: Apr. 29, 2010

(54) Magnetoresistive element including a pair of ferromagnetic layers coupled to a pair of shield layers

(75) Inventors: Takahiko Machita, Tokyo (JP); Daisuke Miyauchi, Tokyo (JP); Tsutomu Chou, Tokyo (JP); Toshiyuki Ayukawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/289,517

(22) Filed: Oct. 29, 2008

(51) Int. Cl. G11B 5/33

(52) U.S. Cl. 360/316; 360/319; G9B/5.104

(57) ABSTRACT

A magnetoresistive element includes first and second shield portions and an MR stack. Each of the first and second shield portions includes a shield bias magnetic field applying layer, and a closed-magnetic-path-forming portion that forms a closed magnetic path in conjunction of the shield bias magnetic field applying layer. The closed-magnetic-path-forming portion includes a single magnetic domain portion. The MR stack is sandwiched between the respective single magnetic domain portions of the first and second shield portions. The closed-magnetic-path-forming portion includes a magnetic-path-expanding portion that forms a magnetic path, the magnetic path being a portion of the closed magnetic path and located between the shield bias magnetic field applying layer and the single magnetic domain portion. The magnetic-path-expanding portion has two end portions located at both ends of the magnetic path, and a middle portion located between the two end portions. A cross section of the magnetic path at the middle portion is greater in width than a cross section of the magnetic path at each of the two end portions.

### BACKGROUND OF THE INVENTION

1. Field of the Invention

The present invention relates to a magnetoresistive element, and to a thin-film magnetic head, a head assembly and a magnetic disk drive each including the magnetoresistive element.

2. Description of the Related Art

Performance improvements in thin-film magnetic heads have been sought as areal recording density of magnetic disk drives has increased. A widely used type of thin-film magnetic head is a composite thin-film magnetic head that has a structure in which a write head and a read head are stacked on a substrate, the write head incorporating an induction-type electromagnetic transducer for writing, the read head incorporating a magnetoresistive element (hereinafter, also referred to as MR element) for reading.

Examples of the MR element include a GMR (giant magnetoresistive) element utilizing a giant magnetoresistive effect, and a TMR (tunneling magnetoresistive) element utilizing a tunneling magnetoresistive effect.

Read heads are required to have characteristics of high sensitivity and high output. As the read heads that satisfy such requirements, those incorporating spin-valve GMR elements or TMR elements have been mass-produced.

A spin-valve GMR element and a TMR element each typically include a free layer, a pinned layer, a spacer layer disposed between the free layer and the pinned layer, and an antiferromagnetic layer disposed on a side of the pinned layer farther from the spacer layer. The free layer is a ferromagnetic layer having a magnetization that changes its direction in response to a signal magnetic field. The pinned layer is a ferromagnetic layer having a magnetization in a fixed direction. The antiferromagnetic layer is a layer that fixes the direction of the magnetization of the pinned layer by means of exchange coupling with the pinned layer. The spacer layer is a nonmagnetic conductive layer in a spin-valve GMR element, and is a tunnel barrier layer in a TMR element.

Examples of a read head incorporating a GMR element include one having a CIP (current-in-plane) structure in which a current used for detecting a signal magnetic field (hereinafter referred to as a sense current) is fed in the direction parallel to the planes of the layers constituting the GMR element, and one having a CPP (current-perpendicular-to-plane) structure in which the sense current is fed in a direction intersecting the planes of the layers constituting the GMR element, such as the direction perpendicular to the planes of the layers constituting the GMR element.

Read heads each incorporate a pair of shields sandwiching the MR element. The distance between the two shields is called a read gap length. Recently, with an increase in recording density, there have been increasing demands for a reduction in track width and a reduction in read gap length in read heads.

As an MR element capable of reducing the read gap length, there has been proposed an MR element including a pair of ferromagnetic layers each functioning as a free layer, and a spacer layer disposed between the pair of ferromagnetic layers (such an MR element is hereinafter referred to as an MR element of the three-layer structure), as disclosed in U.S. Pat. No. 7,035,062 B1, for example. In the MR element of the three-layer structure, the pair of ferromagnetic layers have magnetizations that are in directions antiparallel to each other and parallel to the track width direction when no external magnetic field is applied to those ferromagnetic layers, and that change their directions in response to an external magnetic field.

In a read head incorporating an MR element of the three-layer structure, a bias magnetic field is applied to the pair of ferromagnetic layers. The bias magnetic field changes the directions of the magnetizations of the pair of ferromagnetic layers so that each of the directions forms an angle of approximately 45 degrees with respect to the track width direction. As a result, the relative angle between the directions of the magnetizations of the pair of ferromagnetic layers becomes approximately 90 degrees. When a signal magnetic field sent from the recording medium is applied to the read head, the relative angle between the directions of the magnetizations of the pair of ferromagnetic layers changes, and the resistance of the MR element thereby changes. For this read head, it is possible to detect the signal magnetic field by detecting the resistance of the MR element. The read head incorporating an MR element of the three-layer structure allows a much greater reduction in read gap length, compared with a read head incorporating a conventional GMR element.

For an MR element of the three-layer structure, one of methods for directing the magnetizations of the pair of ferromagnetic layers antiparallel to each other when no external magnetic field is applied thereto is to antiferromagnetically couple the pair of ferromagnetic layers to each other by the RKKY interaction through the spacer layer.

Disadvantageously, however, this method imposes limitation on the material and thickness of the spacer layer to allow antiferromagnetic coupling between the pair of ferromagnetic layers. In addition, since this method limits the material of the spacer layer to a nonmagnetic conductive material, it is not applicable to a TMR element that is expected to have a high output, or a GMR element of a current-confined-path type CPP structure, which is an MR element also expected to have a high output and having a spacer layer that includes a portion allowing the passage of currents and a portion intercepting the passage of currents. The above-described method further has a disadvantage that, even if it could be possible to direct the magnetizations of the pair of ferromagnetic layers antiparallel to each other, it is difficult to direct those magnetizations parallel to the track width direction with reliability.

Under the circumstances, the inventors of the present application have contemplated providing a pair of loop-shaped shields to sandwich an MR element and controlling the directions of the magnetizations of the pair of ferromagnetic layers of the MR element by using the pair of loop-shaped shields. The pair of loop-shaped shields each include a fixed-magnetization portion in which the direction of the magnetization is fixed. The MR element is disposed between the respective fixed-magnetization portions of the pair of loop-shaped shields. The pair of ferromagnetic layers of the MR element are coupled to the fixed-magnetization portions of the pair of loop-shaped shields, whereby the directions of the magnetizations of the pair of ferromagnetic layers are controlled.

A technique of forming a shield into the shape of a loop in order to stabilize the magnetic domain structure of the shield is disclosed in, for example, JP-A-2004-319709 and JP-A-2007-242140. However, these publications do not disclose controlling the directions of the magnetizations of the pair of ferromagnetic layers of an MR element by using a pair of shields.

The inventors of the present application have prototyped a read head in which the directions of the magnetizations of the pair of ferromagnetic layers of the MR element are controlled by the pair of loop-shaped shields as described above, and investigated the characteristic of this read head by performing a quasi static test on the read head. As a result, a phenomenon has been found to occur with high frequency in which the output of the read head abruptly changes to greatly deviate from its ideal value when the external magnetic field is of certain magnitude. This phenomenon is undesirable because it becomes a cause of noise in the output of the read head.

### OBJECT AND SUMMARY OF THE INVENTION

It is an object of the present invention to provide a magnetoresistive element including a pair of ferromagnetic layers whose magnetizations change their directions in response to an external magnetic field, and a spacer layer disposed between the pair of ferromagnetic layers, the magnetoresistive element being capable of directing the magnetizations of the pair of ferromagnetic layers antiparallel to each other when no external magnetic field is applied, without making use of antiferromagnetic coupling between the pair of ferromagnetic layers through the spacer layer, and also capable of suppressing the occurrence of an abrupt change in output, and to provide a thin-film magnetic head, a head assembly and a magnetic disk drive each including such a magnetoresistive element.

A magnetoresistive element of the present invention includes a first shield portion, a second shield portion, and an MR stack. The first shield portion includes: a first shield bias magnetic field applying layer that generates a first shield bias magnetic field; and a first closed-magnetic-path-forming portion that forms a first closed magnetic path in conjunction with the first shield bias magnetic field applying layer. The first closed-magnetic-path-forming portion includes a first single magnetic domain portion that is brought into a single magnetic domain state such that a magnetization thereof is directed to a first direction by a magnetic flux generated by the first shield bias magnetic field and passing through the first closed magnetic path. The second shield portion includes: a second shield bias magnetic field applying layer that generates a second shield bias magnetic field; and a second closed-magnetic-path-forming portion that forms a second closed magnetic path in conjunction with the second shield bias magnetic field applying layer. The second closed-magnetic-path-forming portion includes a second single magnetic domain portion that is brought into a single magnetic domain state such that a magnetization thereof is directed to a second direction by a magnetic flux generated by the second shield bias magnetic field and passing through the second closed magnetic path.

The first and second single magnetic domain portions and the MR stack are disposed such that the MR stack is sandwiched between the first and second single magnetic domain portions. The MR stack includes: a first ferromagnetic layer magnetically coupled to the first single magnetic domain portion; a second ferromagnetic layer magnetically coupled to the second single magnetic domain portion; and a spacer layer made of a nonmagnetic material and disposed between the first and second ferromagnetic layers.

The first closed-magnetic-path-forming portion further includes a first magnetic-path-expanding portion that is formed of a magnetic layer having two surfaces facing toward opposite directions and that forms a first magnetic path, the first magnetic path being a portion of the first closed magnetic path and being located between the first shield bias magnetic field applying layer and the first single magnetic domain portion. The first magnetic-path-expanding portion has two end portions located at both ends of the first magnetic path, and a middle portion located between the two end portions. A cross section of the first magnetic path at the middle portion is greater in width than a cross section of the first magnetic path at each of the two end portions, the width being taken in a direction parallel to the two surfaces.

The second closed-magnetic-path-forming portion further includes a second magnetic-path-expanding portion that is formed of a magnetic layer having two surfaces facing toward opposite directions and that forms a second magnetic path, the second magnetic path being a portion of the second closed magnetic path and being located between the second shield bias magnetic field applying layer and the second single magnetic domain portion. The second magnetic-path-expanding portion has two end portions located at both ends of the second magnetic path, and a middle portion located between the two end portions. A cross section of the second magnetic path at the middle portion is greater in width than a cross section of the second magnetic path at each of the two end portions, the width being taken in a direction parallel to the two surfaces.

According to the present invention, the first closed-magnetic-path-forming portion includes the first magnetic-path-expanding portion while the second closed-magnetic-path-forming portion includes the second magnetic-path-expanding portion. This allows the first and second closed-magnetic-path-forming portions to be magnetically stable.

In the magnetoresistive element of the present invention, the first direction and the second direction may be antiparallel to each other. In this case, the first and second shield bias magnetic field applying layers may each have a magnetization directed to a third direction different from the first and second directions.

In the magnetoresistive element of the present invention, the first shield bias magnetic field applying layer may have a first end and a second end. The first closed-magnetic-path-forming portion may include: a first portion that includes the first single magnetic domain portion and that is connected to the first end of the first shield bias magnetic field applying layer; and a second portion connected to the second end of the first shield bias magnetic field applying layer. In this case, one of the two end portions of the first magnetic-path-expanding portion may be connected to the first portion of the first closed-magnetic-path-forming portion so that a magnetic path passing through the first single magnetic domain portion is formed between this one of the two end portions and the first end of the first shield bias magnetic field applying layer, while the other of the two end portions of the first magnetic-path-expanding portion may be connected to the second portion of the first closed-magnetic-path-forming portion.

Similarly, the second shield bias magnetic field applying layer may have a first end and a second end. The second closed-magnetic-path-forming portion may include: a first portion that includes the second single magnetic domain portion and that is connected to the first end of the second shield bias magnetic field applying layer; and a second portion connected to the second end of the second shield bias magnetic field applying layer. In this case, one of the two end portions of the second magnetic-path-expanding portion may be connected to the first portion of the second closed-magnetic-path-forming portion so that a magnetic path passing through the second single magnetic domain portion is formed between this one of the two end portions and the first end of the second shield bias magnetic field applying layer, while the other of the two end portions of the second magnetic-path-expanding portion may be connected to the second portion of the second closed-magnetic-path-forming portion.

The first magnetic-path-expanding portion may be disposed to overlap the first and second portions of the first closed-magnetic-path-forming portion as seen in a direction perpendicular to the two surfaces of the first magnetic-path-expanding portion, and the two end portions of the first magnetic-path-expanding portion may be included in one of the two surfaces. In this case, the first shield portion may further include a first separating layer that magnetically separates the first and second portions of the first closed-magnetic-path-forming portion from the first magnetic-path-expanding portion except the two end portions.

Similarly, the second magnetic-path-expanding portion may be disposed to overlap the first and second portions of the second closed-magnetic-path-forming portion as seen in a direction perpendicular to the two surfaces of the second magnetic-path-expanding portion, and the two end portions of the second magnetic-path-expanding portion may be included in one of the two surfaces. In this case, the second shield portion may further include a second separating layer that magnetically separates the first and second portions of the second closed-magnetic-path-forming portion from the second magnetic-path-expanding portion except the two end portions.

In the magnetoresistive element of the present invention, the MR stack may further include: a first coupling layer disposed between the first single magnetic domain portion and the first ferromagnetic layer and magnetically coupling the first ferromagnetic layer to the first single magnetic domain portion; and a second coupling layer disposed between the second single magnetic domain portion and the second ferromagnetic layer and magnetically coupling the second ferromagnetic layer to the second single magnetic domain portion. In this case, each of the first and second coupling layers may include a nonmagnetic conductive layer. Alternatively, at least one of the first and second coupling layers may include a magnetic layer, and two nonmagnetic conductive layers sandwiching the magnetic layer.

The magnetoresistive element of the present invention may further include a bias magnetic field applying layer disposed between the first and second shield portions so as to be adjacent to the MR stack in a direction orthogonal to a direction in which the layers constituting the MR stack are stacked, the bias magnetic field applying layer applying a bias magnetic field to the first and second ferromagnetic layers so that magnetizations of the first and second ferromagnetic layers change their directions compared with a state in which no bias magnetic field is applied to the first and second ferromagnetic layers. In this case, the bias magnetic field applying layer may apply the bias magnetic field to the first and second ferromagnetic layers so that the magnetizations of the first and second ferromagnetic layers are directed orthogonal to each other. The bias magnetic field applying layer and the first and second shield bias magnetic field applying layers may have magnetizations directed to the same direction.

A thin-film magnetic head of the present invention includes: a medium facing surface that faces toward a recording medium; and the magnetoresistive element of the invention disposed near the medium facing surface to detect a signal magnetic field sent from the recording medium.

A head assembly of the present invention includes: a slider including the thin-film magnetic head of the invention and disposed to face toward the recording medium; and a supporter flexibly supporting the slider.

A magnetic disk drive of the present invention includes: a slider including the thin-film magnetic head of the invention and disposed to face toward a recording medium that is driven to rotate; and an alignment device supporting the slider and aligning the slider with respect to the recording medium.

According to the present invention, the first ferromagnetic layer of the MR stack is magnetically coupled to the first single magnetic domain portion of the first closed-magnetic-path-forming portion, and the second ferromagnetic layer of the MR stack is magnetically coupled to the second single magnetic domain portion of the second closed-magnetic-path-forming portion. The directions of the magnetizations of the first and second ferromagnetic layers are thereby controlled. The present invention thus makes it possible to direct the magnetizations of the pair of ferromagnetic layers antiparallel to each other when no external magnetic field is applied, without making use of antiferromagnetic coupling between the pair of ferromagnetic layers through the spacer layer.

Furthermore, according to the present invention, the first closed-magnetic-path-forming portion includes the first magnetic-path-expanding portion, and the second closed-magnetic-path-forming portion includes the second magnetic-path-expanding portion. This allows the first and second closed-magnetic-path-forming portions to be magnetically stable. As a result, according to the present invention, it is possible to suppress the occurrence of an abrupt change in output of the magnetoresistive element.

Other and further objects, features and advantages of the present invention will appear more fully from the following description.

### BRIEF DESCRIPTION OF THE DRAWINGS

FIG. 1 is an exploded perspective view of a main part of a magnetoresistive element of a first embodiment of the invention.

FIG. 2 is a cross-sectional view showing a cross section of the magnetoresistive element of the first embodiment of the invention parallel to the medium facing surface.

FIG. 3 is a cross-sectional view showing a cross section of the magnetoresistive element of FIG. 2 perpendicular to the medium facing surface and the top surface of the substrate.

FIG. 4 is an enlarged cross-sectional view of the MR stack of FIG. 2.

FIG. 5A is a plan view of a part of a first read shield portion of the first embodiment of the invention.

FIG. 5B is a cross-sectional view of the part of the first read shield portion of FIG. 5A taken along line 5B-5B.

FIG. 5C is a cross-sectional view of the part of the first read shield portion of FIG. 5A taken along line 5C-5C.

FIG. 6A is a plan view showing a magnetic-path-expanding portion and a separating layer of the first read shield portion of the first embodiment of the invention.

FIG. 6B is a cross-sectional view of the magnetic-path-expanding portion and the separating layer of FIG. 6A taken along line 6B-6B.

FIG. 7A is a plan view of the first read shield portion of the first embodiment of the invention.

FIG. 7B is a cross-sectional view of the first read shield portion of FIG. 7A taken along line 7B-7B.

FIG. 7C is a cross-sectional view of the first read shield portion of FIG. 7A taken along line 7C-7C.

FIG. 8A is a plan view of a read shield portion of a comparative example.

FIG. 8B is a cross-sectional view of the read shield portion of the comparative example of FIG. 8A taken along line 8B-8B.

FIG. 8C is a cross-sectional view of the read shield portion of the comparative example of FIG. 8A taken along line 8C-8C.

FIG. 9A is a plan view of a part of a second read shield portion of the first embodiment of the invention.

FIG. 9B is a cross-sectional view of the part of the second read shield portion of FIG. 9A taken along line 9B-9B.

FIG. 9C is a cross-sectional view of the part of the second read shield portion of FIG. 9A taken along line 9C-9C.

FIG. 10A is a plan view showing a magnetic-path-expanding portion and a separating layer of the second read shield portion of the first embodiment of the invention.

FIG. 10B is a cross-sectional view of the magnetic-path-expanding portion and the separating layer of FIG. 10A taken along line 10B-10B.

FIG. 11A is a plan view of the second read shield portion of the first embodiment of the invention.

FIG. 11B is a cross-sectional view of the second read shield portion of FIG. 11A taken along line 11B-11B.

FIG. 11C is a cross-sectional view of the second read shield portion of FIG. 1A taken along line 11C-11C.

FIG. 12 is a cross-sectional view showing the configuration of a thin-film magnetic head of the first embodiment of the invention.

FIG. 13 is a front view showing the medium facing surface of the thin-film magnetic head of the first embodiment of the invention.

FIG. 14 is an illustrative view for explaining the operation of the magnetoresistive element of the first embodiment of the invention.

FIG. 15 is an illustrative view for explaining the operation of the magnetoresistive element of the first embodiment of the invention.

FIG. 16 is an illustrative view for explaining the operation of the magnetoresistive element of the first embodiment of the invention.

FIG. 17 is an exploded perspective view of a main part of a magnetoresistive element of a comparative example.

FIG. 18 is a plot showing the characteristic of the magnetoresistive element of the comparative example.

FIG. 19 is a plot showing the characteristic of the magnetoresistive element of the first embodiment of the invention.

FIG. 20 is a perspective view of a slider including the thin-film magnetic head of the first embodiment of the invention.

FIG. 21 is a perspective view of a head arm assembly of the first embodiment of the invention.

FIG. 22 is an illustrative view for illustrating a main part of a magnetic disk drive of the first embodiment of the invention.

FIG. 23 is a plan view of the magnetic disk drive of the first embodiment of the invention.

FIG. 24A is a plan view of a part of a first read shield portion of a second embodiment of the invention.

FIG. 24B is a cross-sectional view of the part of the first read shield portion of FIG. 24A taken along line 24B-24B.

FIG. 24C is a cross-sectional view of the part of the first read shield portion of FIG. 24A taken along line 24C-24C.

FIG. 25A is a plan view showing a magnetic-path-expanding portion and a separating layer of the first read shield portion of the second embodiment of the invention.

FIG. 25B is a cross-sectional view of the magnetic-path-expanding portion and the separating layer of FIG. 25A taken along line 25B-25B.

FIG. 26A is a plan view of the first read shield portion of the second embodiment of the invention.

FIG. 26B is a cross-sectional view of the first read shield portion of FIG. 26A taken along line 26B-26B.

FIG. 26C is a cross-sectional view of the first read shield portion of FIG. 26A taken along line 26C-26C.

FIG. 27 is a plan view of a first read shield portion of a third embodiment of the invention.

FIG. 28 is a plan view of a second read shield portion of the third embodiment of the invention.

### DETAILED DESCRIPTION OF THE PREFERRED EMBODIMENTS

### First Embodiment

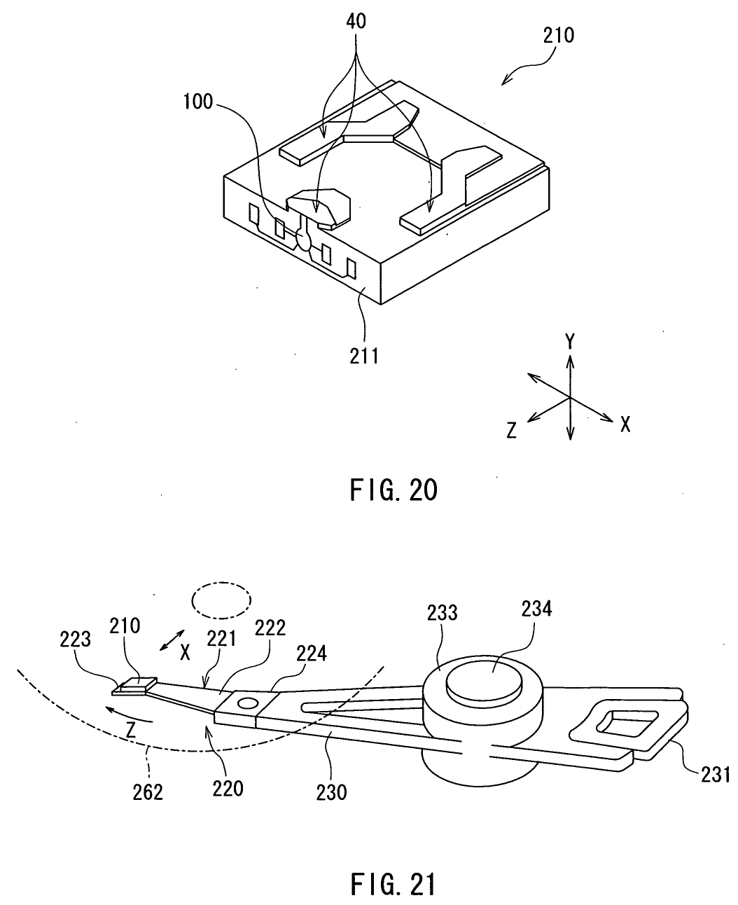

Embodiments of the present invention will now be described in detail with reference to the drawings. Reference is first made to FIG. 20 to describe a slider 210 including a thin-film magnetic head of a first embodiment of the invention. In a magnetic disk drive, the slider 210 is placed to face toward a circular-plate-shaped recording medium (a magnetic disk platter) that is to be driven to rotate. In FIG. 20, the X direction is across the tracks of the recording medium, the Y direction is perpendicular to the surface of the recording medium, and the Z direction is the direction of travel of the recording medium as seen from the slider 210. The X, Y and Z directions are orthogonal to one another. The slider 210 has a base body 211. The base body 211 is nearly hexahedron-shaped. One of the six surfaces of the base body 211 is designed to face toward the surface of the recording medium. At this one of the six surfaces, there is formed a medium facing surface 40 to face toward the recording medium. When the recording medium rotates and travels in the Z direction, an airflow passing between the recording medium and the slider 210 causes a lift below the slider 210 in the Y direction of FIG. 20. This lift causes the slider 210 to fly over the surface of the recording medium. The thin-film magnetic head 100 of the present embodiment is formed near the air-outflow-side end (the end located at the lower left of FIG. 20) of the slider 210.

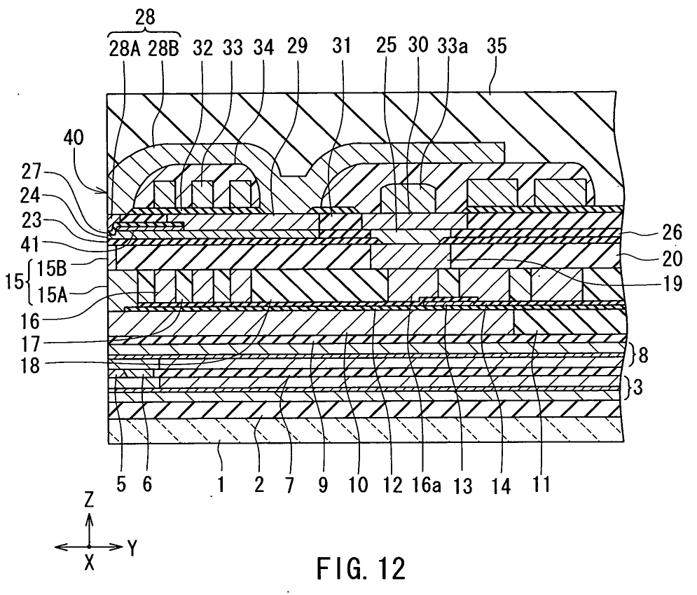

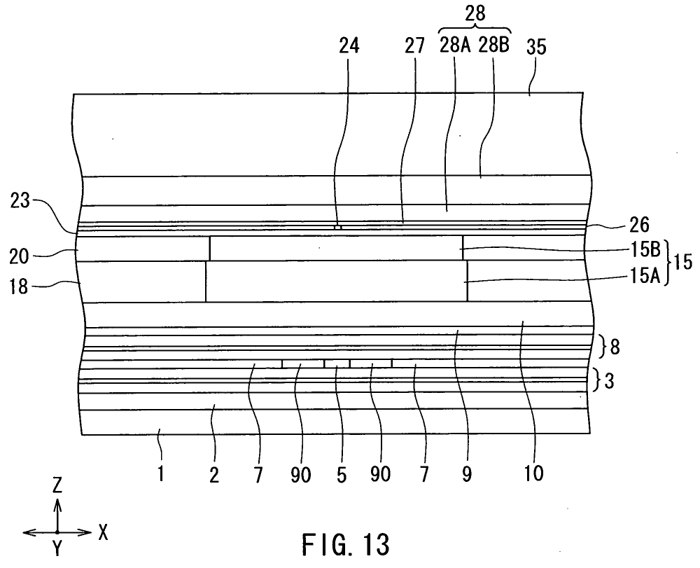

Reference is now made to FIG. 12 and FIG. 13 to describe the configuration of the thin-film magnetic head of the present embodiment. FIG. 12 is a cross-sectional view showing the configuration of the thin-film magnetic head. FIG. 13 is a front view showing the medium facing surface of the thin-film magnetic head. Note that FIG. 12 shows a cross section perpendicular to the medium facing surface and the top surface of the substrate. The X, Y and Z directions shown in FIG. 20 are also shown in FIG. 12 and FIG. 13. In FIG. 12 the X direction is orthogonal to the Y and Z directions. In FIG. 13 the Y direction is orthogonal to the X and Z directions.

As shown in FIG. 12, the thin-film magnetic head of the present embodiment has the medium facing surface 40 that faces toward the recording medium. As shown in FIG. 12 and FIG. 13, the thin-film magnetic head includes: a substrate 1 made of a ceramic material such as aluminum oxide-titanium carbide (Al₂O₃—TiC); an insulating layer 2 made of an insulating material such as alumina (Al₂O₃) and disposed on the substrate 1; a first read shield portion 3 disposed on the insulating layer 2; and an MR stack 5, a bias magnetic field applying layer 6 and an insulating refill layer 7 that are disposed on the first read shield portion 3.

The MR stack 5 has a bottom surface touching the first read shield portion 3, a top surface opposite to the bottom surface, a front end face located in the medium facing surface 40, a rear end face opposite to the front end face, and two side surfaces that are opposed to each other in the track width direction (the X direction of FIG. 13). The bias magnetic field applying layer 6 is disposed adjacent to the rear end face of the MR stack 5, with an insulating film (not shown) provided between the MR stack 5 and the layer 6. The insulating refill layer 7 is disposed around the MR stack 5 and the bias magnetic field applying layer 6.

The thin-film magnetic head further includes: a second read shield portion 8 disposed on the MR stack 5, the bias magnetic field applying layer 6 and the insulating refill layer 7; and a separating layer 9 made of a nonmagnetic material such as alumina and disposed on the second read shield portion 8.

The portion from the first read shield portion 3 to the second read shield portion 8 constitutes a magnetoresistive element (hereinafter referred to as MR element) of the present embodiment. The MR element constitutes a read head of the thin-film magnetic head of the present embodiment. The configuration of the MR element will be described in detail later.

The thin-film magnetic head further includes: a magnetic layer 10 made of a magnetic material and disposed on the separating layer 9; and an insulating layer 11 made of an insulating material such as alumina and disposed around the magnetic layer 10. The magnetic layer 10 has an end face located in the medium facing surface 40. The magnetic layer 10 and the insulating layer 11 have flattened top surfaces.

The thin-film magnetic head further includes: an insulating film 12 disposed on the magnetic layer 10 and the insulating layer 11; a heater 13 disposed on the insulating film 12; and an insulating film 14 disposed on the insulating film 12 and the heater 13 such that the heater 13 is sandwiched between the insulating films 12 and 14. The function and material of the heater 13 will be described later. The insulating films 12 and 14 are made of an insulating material such as alumina.

The thin-film magnetic head further includes a first write shield 15 disposed on the magnetic layer 10. The first write shield 15 includes: a first layer 15A disposed on the magnetic layer 10; and a second layer 15B disposed on the first layer 15A. The first layer 15A and the second layer 15B are made of a magnetic material. Each of the first layer 15A and the second layer 15B has an end face located in the medium facing surface 40. In the example shown in FIG. 12, the length of the second layer 15B taken in the direction perpendicular to the medium facing surface 40 (the Y direction of FIG. 12) is smaller than the length of the first layer 15A taken in the direction perpendicular to the medium facing surface 40. However, the length of the second layer 15B taken in the direction perpendicular to the medium facing surface 40 may be equal to or greater than the length of the first layer 15A taken in the direction perpendicular to the medium facing surface 40.

The thin-film magnetic head further includes: a coil 16 made of a conductive material and disposed on the insulating film 14; an insulating layer 17 that fills the space between the coil 16 and the first layer 15A and the space between every adjacent turns of the coil 16; and an insulating layer 18 disposed around the first layer 15A, the coil 16 and the insulating layer 17. The coil 16 is planar spiral-shaped. The coil 16 includes a connecting portion 16a that is a portion near an inner end of the coil 16 and connected to another coil described later. The insulating layer 17 is made of photoresist, for example. The insulating layer 18 is made of alumina, for example. The first layer 15A, the coil 16, the insulating layer 17 and the insulating layer 18 have flattened top surfaces.

The thin-film magnetic head further includes: a connecting layer 19 made of a conductive material and disposed on the connecting portion 16a; and an insulating layer 20 made of an insulating material such as alumina and disposed around the second layer 15B and the connecting layer 19. The connecting layer 19 may be made of the same material as the second layer 15B. The second layer 15B, the connecting layer 19 and the insulating layer 20 have flattened top surfaces.

The thin-film magnetic head further includes a first gap layer 23 disposed on the second layer 15B, the connecting layer 19 and the insulating layer 20. The first gap layer 23 has an opening formed in a region corresponding to the top surface of the connecting layer 19. The first gap layer 23 is made of a nonmagnetic insulating material such as alumina.

The thin-film magnetic head further includes: a pole layer 24 made of a magnetic material and disposed on the first gap layer 23; a connecting layer 25 made of a conductive material and disposed on the connecting layer 19; and an insulating layer 26 made of an insulating material such as alumina and disposed around the pole layer 24 and the connecting layer 25. The pole layer 24 has an end face located in the medium facing surface 40. The connecting layer 25 is connected to the connecting layer 19 through the opening of the first gap layer 23. The connecting layer 25 may be made of the same material as the pole layer 24.

The thin-film magnetic head further includes a nonmagnetic layer 41 made of a nonmagnetic material and disposed on part of the top surface of the pole layer 24. The nonmagnetic layer 41 is made of an inorganic insulating material or a metal material, for example. Examples of the inorganic insulating material to be used for the nonmagnetic layer 41 include alumina and SiO₂. Examples of the metal material to be used for the nonmagnetic layer 41 include Ru and Ti.

The thin-film magnetic head further includes a second gap layer 27 disposed on part of the pole layer 24 and on the nonmagnetic layer 41. A portion of the top surface of the pole layer 24 apart from the medium facing surface 40 and the top surface of the connecting layer 25 are not covered with the nonmagnetic layer 41 and the second gap layer 27. The second gap layer 27 is made of a nonmagnetic material such as alumina.

The thin-film magnetic head further includes a second write shield 28 disposed on the second gap layer 27. The second write shield 28 includes: a first layer 28A disposed adjacent to the second gap layer 27; and a second layer 28B disposed on a side of the first layer 28A opposite to the second gap layer 27 and connected to the first layer 28A. The first layer 28A and the second layer 28B are made of a magnetic material. Each of the first layer 28A and the second layer 28B has an end face located in the medium facing surface 40.

The thin-film magnetic head further includes: a yoke layer 29 made of a magnetic material and disposed on a portion of the pole layer 24 away from the medium facing surface 40; a connecting layer 30 made of a conductive material and disposed on the connecting layer 25; and an insulating layer 31 made of an insulating material such as alumina and disposed around the first layer 28A, the yoke layer 29 and the connecting layer 30. The yoke layer 29 and the connecting layer 30 may be made of the same material as the first layer 28A. The first layer 28A, the yoke layer 29, the connecting layer 30 and the insulating layer 31 have flattened top surfaces.

The thin-film magnetic head further includes an insulating layer 32 made of an insulating material such as alumina and disposed on the yoke layer 29 and the insulating layer 31. The insulating layer 32 has an opening for exposing the top surface of the first layer 28A, an opening for exposing a portion of the top surface of the yoke layer 29 near an end thereof farther from the medium facing surface 40, and an opening for exposing the top surface of the connecting layer 30.

The thin-film magnetic head further includes a coil 33 made of a conductive material and disposed on the insulating layer 32. The coil 33 is planar spiral-shaped. The coil 33 includes a connecting portion 33a that is a portion near an inner end of the coil 33 and connected to the connecting portion 16a of the coil 16. The connecting portion 33a is connected to the connecting layer 30, and connected to the connecting portion 16a through the connecting layers 19, 25 and 30.

The thin-film magnetic head further includes an insulating layer 34 disposed to cover the coil 33. The insulating layer 34 is made of photoresist, for example. The second layer 28B of the second write shield 28 is disposed on the first layer 28A, the yoke layer 29 and the insulating layer 34, and connects the first layer 28A and the yoke layer 29 to each other.

The thin-film magnetic head further includes an overcoat layer 35 made of an insulating material such as alumina and disposed to cover the second layer 28B. The portion from the magnetic layer 10 to the second layer 28B constitutes a write head. The base body 211 of FIG. 20 is mainly composed of the substrate 1 and the overcoat layer 35 of FIG. 12.

As described so far, the thin-film magnetic head includes the medium facing surface 40 that faces toward the recording medium, the read head, and the write head. The read head and the write head are stacked on the substrate 1. The read head is disposed backward along the direction of travel of the recording medium (the Z direction) (in other words, disposed closer to an air-inflow end of the slider), while the write head is disposed forward along the direction of travel of the recording medium (the Z direction) (in other words, disposed closer to an air-outflow end of the slider). The thin-film magnetic head writes data on the recording medium through the use of the write head, and reads data stored on the recording medium through the use of the read head.

As shown in FIG. 12 and FIG. 13, the read head includes the first read shield portion 3, the second read shield portion 8, the MR stack 5 that is disposed between the first and second read shield portions 3 and 8 near the medium facing surface 40 in order to detect a signal magnetic field sent from the recording medium, and the bias magnetic field applying layer 6 and the insulating refill layer 7 that are disposed between the first and second read shield portions 3 and 8. The bias magnetic field applying layer 6 is disposed adjacent to the rear end face of the MR stack 5, with an insulating film (not shown) provided between the MR stack 5 and the layer 6. The insulating refill layer 7 is disposed around the MR stack 5 and the bias magnetic field applying layer 6. The MR stack 5 is either a TMR element or a GMR element of the CPP structure. A sense current is fed to the MR stack 5 in a direction intersecting the planes of layers constituting the MR stack 5, such as the direction perpendicular to the planes of the layers constituting the MR stack 5. The resistance of the MR stack 5 changes in response to an external magnetic field, that is, a signal magnetic field sent from the recording medium. The resistance of the MR stack 5 can be determined from the sense current. It is thus possible, using the read head, to read data stored on the recording medium.

The write head includes the magnetic layer 10, the first write shield 15, the coil 16, the first gap layer 23, the pole layer 24, the nonmagnetic layer 41, the second gap layer 27, the second write shield 28, the yoke layer 29, and the coil 33. The first write shield 15 is located closer to the substrate 1 than is the second write shield 28. The pole layer 24 is located closer to the substrate 1 than is the second write shield 28.

The coils 16 and 33 generate a magnetic field that corresponds to data to be written on the recording medium. The pole layer 24 has an end face located in the medium facing surface 40, allows a magnetic flux corresponding to the magnetic field generated by the coils 16 and 33 to pass, and generates a write magnetic field used for writing the data on the recording medium by means of a perpendicular magnetic recording system.

The first write shield 15 is made of a magnetic material, and has an end face located in the medium facing surface 40 at a position backward of the end face of the pole layer 24 along the direction of travel of the recording medium (the Z direction). The first gap layer 23 is made of a nonmagnetic material, has an end face located in the medium facing surface 40, and is disposed between the first write shield 15 and the pole layer 24. In the present embodiment, the first write shield 15 includes the first layer 15A disposed on the magnetic layer 10, and the second layer 15B disposed on the first layer 15A. Part of the coil 16 is located on a side of the first layer 15A so as to pass through the space between the magnetic layer 10 and the pole layer 24.

The magnetic layer 10 has a function of returning a magnetic flux that has been generated from the end face of the pole layer 24 and has magnetized the recording medium. FIG. 12 shows an example in which the magnetic layer 10 has an end face located in the medium facing surface 40. However, since the magnetic layer 10 is connected to the first write shield 15 having an end face located in the medium facing surface 40, the magnetic layer 10 may have an end face that is closer to the medium facing surface 40 and located at a distance from the medium facing surface 40.

In the medium facing surface 40, the end face of the first write shield 15 (the end face of the second layer 15B) is located backward of the end face of the pole layer 24 along the direction of travel of the recording medium (the Z direction) (in other words, located closer to the air-inflow end of the slider) with a predetermined small distance provided therebetween by the first gap layer 23. The distance between the end face of the pole layer 24 and the end face of the first write shield 15 in the medium facing surface 40 is preferably within a range of 0.05 to 0.7 μm, or more preferably within a range of 0.1 to 0.3 μm.

The first write shield 15 takes in a magnetic flux that is generated from the end face of the pole layer 24 located in the medium facing surface 40 and that expands in directions except the direction perpendicular to the plane of the recording medium, and thereby prevents this flux from reaching the recording medium. It is thereby possible to improve the recording density.

The second write shield 28 is made of a magnetic material, and has an end face located in the medium facing surface 40 at a position forward of the end face of the pole layer 24 along the direction of travel of the recording medium (the Z direction). The second gap layer 27 is made of a nonmagnetic material, has an end face located in the medium facing surface 40, and is disposed between the second write shield 28 and the pole layer 24. In the present embodiment, the second write shield 28 includes: the first layer 28A disposed adjacent to the second gap layer 27; and the second layer 28B disposed on a side of the first layer 28A opposite to the second gap layer 27 and connected to the first layer 28A. Part of the coil 33 is disposed to pass through the space surrounded by the pole layer 24 and the second write shield 28. The second write shield 28 is connected to a portion of the yoke layer 29 away from the medium facing surface 40. The second write shield 28 is thus connected to a portion of the pole layer 24 away from the medium facing surface 40 through the yoke layer 29. The pole layer 24, the second write shield 28 and the yoke layer 29 form a magnetic path that allows a magnetic flux corresponding to the magnetic field generated by the coil 33 to pass therethrough.

In the medium facing surface 40, the end face of the second write shield 28 (the end face of the first layer 28A) is located forward of the end face of the pole layer 24 along the direction of travel of the recording medium (the Z direction) (in other words, located closer to the air-outflow end of the slider) with a predetermined small distance provided therebetween by the second gap layer 27. The distance between the end face of the pole layer 24 and the end face of the second write shield 28 in the medium facing surface 40 is preferably equal to or smaller than 200 nm, or more preferably within a range of 25 to 50 nm, so that the second write shield 28 can fully exhibit its function as a shield.

The position of the end of a bit pattern to be written on the recording medium is determined by the position of an end of the pole layer 24 closer to the second gap layer 27 in the medium facing surface 40. The second write shield 28 takes in a magnetic flux that is generated from the end face of the pole layer 24 located in the medium facing surface 40 and that expands in directions except the direction perpendicular to the plane of the recording medium, and thereby prevents this flux from reaching the recording medium. It is thereby possible to improve the recording density. Furthermore, the second write shield 28 takes in a disturbance magnetic field applied from outside the thin-film magnetic head to the thin-film magnetic head. It is thereby possible to prevent erroneous writing on the recording medium caused by the disturbance magnetic field intensively taken into the pole layer 24. The second write shield 28 also has a function of returning a magnetic flux that has been generated from the end face of the pole layer 24 and has magnetized the recording medium.

FIG. 12 shows an example in which neither the magnetic layer 10 nor the first write shield 15 is connected to the pole layer 24. However, the magnetic layer 10 may be connected to a portion of the pole layer 24 away from the medium facing surface 40. The coil 16 is not an essential component of the write head and can be dispensed with. In the example shown in FIG. 12, the yoke layer 29 is disposed on the pole layer 24, or in other words, disposed forward of the pole layer 24 along the direction of travel of the recording medium (the Z direction) (or in still other words, disposed closer to the air-outflow end of the slider). However, the yoke layer 29 may be disposed below the pole layer 24, or in other words, disposed backward of the pole layer 24 along the direction of travel of the recording medium (the Z direction) (or in still other words, disposed closer to the air-inflow end of the slider).

The heater 13 is provided for heating the components of the write head including the pole layer 24 so as to control the distance between the recording medium and the end face of the pole layer 24 located in the medium facing surface 40. Two leads that are not shown are connected to the heater 13. For example, the heater 13 is formed of a NiCr film or a layered film made up of a Ta film, a NiCu film and a Ta film. The heater 13 generates heat by being energized through the two leads, and thereby heats the components of the write head. As a result, the components of the write head expand and the end face of the pole layer 24 located in the medium facing surface 40 thereby gets closer to the recording medium.

While FIG. 12 and FIG. 13 show a write head for a perpendicular magnetic recording system, the write head of the present embodiment may be one for a longitudinal magnetic recording system.

A method of manufacturing the thin-film magnetic head of the present embodiment will now be outlined. In the method of manufacturing the thin-film magnetic head of the embodiment, first, components of a plurality of thin-film magnetic heads are formed on a single substrate (wafer) to thereby fabricate a substructure in which pre-slider portions each of which will later become a slider are aligned in a plurality of rows. Next, the substructure is cut to form a slider aggregate including a plurality of pre-slider portions aligned in a row. Next, a surface formed in the slider aggregate by cutting the substructure is lapped to thereby form the medium facing surfaces 40 of the pre-slider portions included in the slider aggregate. Next, flying rails are formed in the medium facing surfaces 40. Next, the slider aggregate is cut so as to separate the plurality of pre-slider portions from one another, whereby a plurality of sliders are formed, each of the sliders including the thin-film magnetic head.

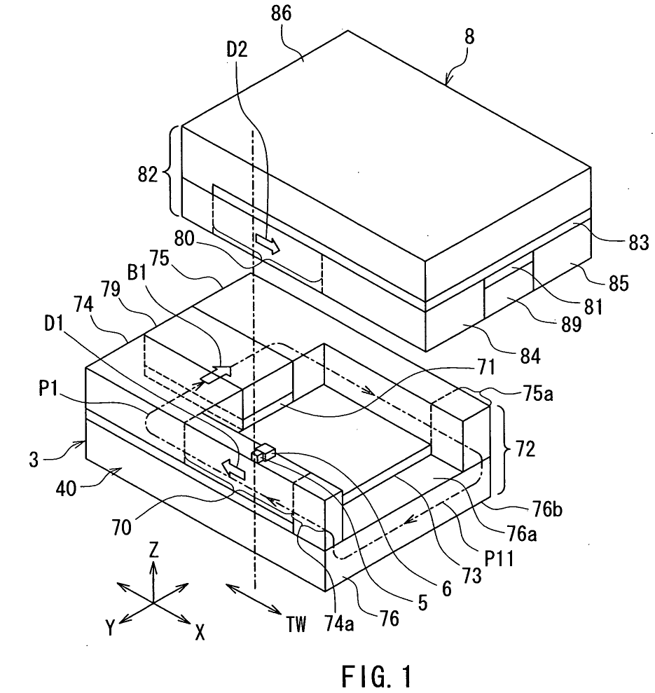

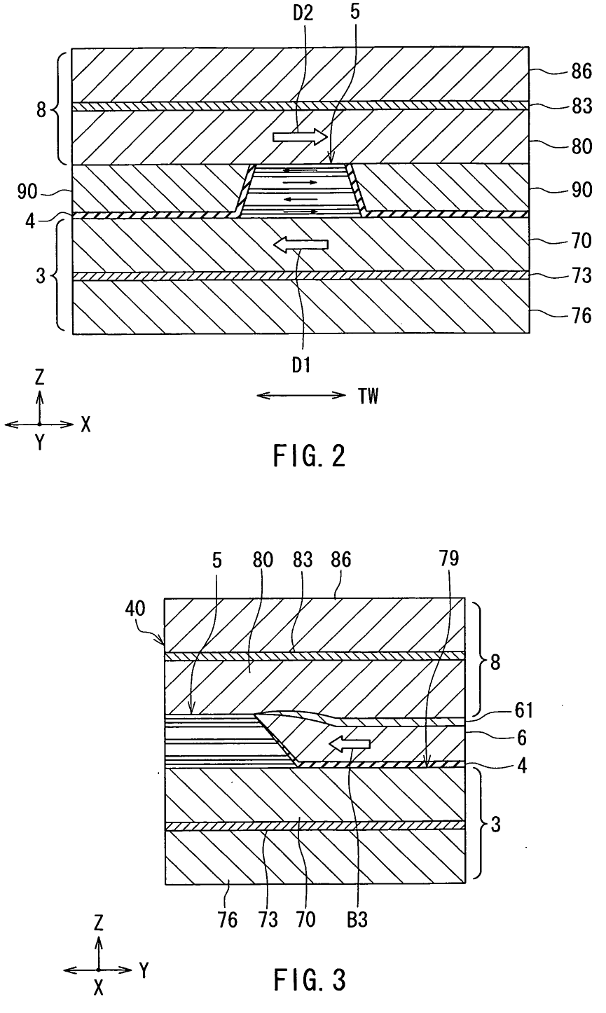

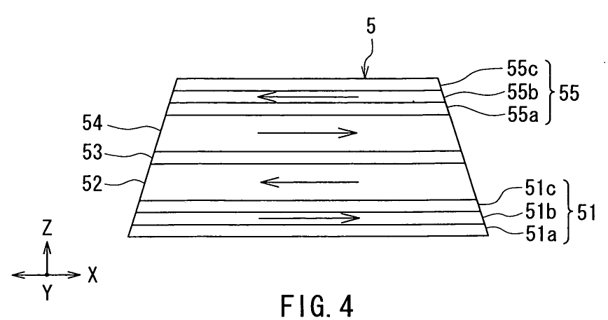

The configuration of the MR element of the present embodiment will now be described in detail with reference to FIG. 1 to FIG. 4. FIG. I is an exploded perspective view of a main part of the MR element. FIG. 2 is a cross-sectional view showing a cross section of the MR element parallel to the medium facing surface 40. FIG. 3 is a cross-sectional view showing a cross section of the MR element perpendicular to the medium facing surface 40 and the top surface of the substrate 1. FIG. 4 is an enlarged cross-sectional view of the MR stack of FIG. 2. The X, Y and Z directions shown in FIG. 20 are also shown in FIG. 1 to FIG. 4. In FIG. 2 and FIG. 4 the Y direction is orthogonal to the X and Z directions. In FIG. 3 the X direction is orthogonal to the Y and Z directions. In FIG. 1 and FIG. 2 the arrow TW indicates the track width direction. The track width direction TW is the same as the X direction.

As shown in FIG. 2 and FIG. 3, the MR element includes the first read shield portion 3 and the second read shield portion 8, and includes the MR stack 5, an insulating film 4, two nonmagnetic metal layers 90, the bias magnetic field applying layer 6, a protection layer 61 and the insulating refill layer 7 that are disposed between the read shield portions 3 and 8 (see FIG. 12). The MR stack 5 and the second read shield portion 8 are stacked in this order on the first read shield portion 3. The first read shield portion 3 corresponds to the first shield portion of the present invention. The second read shield portion 8 corresponds to the second shield portion of the present invention.

As shown in FIG. 2, the insulating film 4 covers the two side surfaces and the rear end face of the MR stack 5, and also covers the top surface of the first read shield portion 3 except the area on which the MR stack 5 is disposed. The insulating film 4 is formed of an insulating material such as alumina. The two nonmagnetic metal layers 90 are disposed adjacent to the two side surfaces of the MR stack 5, respectively, with the insulating film 4 located between the MR stack 5 and the nonmagnetic metal layers 90. The nonmagnetic metal layers 90 are formed of a nonmagnetic metal material such as Cr. As shown in FIG. 3, the bias magnetic field applying layer 6 is disposed adjacent to the rear end face of the MR stack 5, with the insulating film 4 located between the MR stack 5 and the bias magnetic field applying layer 6. The bias magnetic field applying layer 6 is formed mainly of a hard magnetic material (permanent magnet material) such as CoPt or CoCrPt. As shown in FIG. 3, the protection layer 61 is disposed between the bias magnetic field applying layer 6 and the second read shield portion 8. The protection layer 61 is formed of a nonmagnetic conductive material such as NiCr. The insulating refill layer 7 is disposed around the nonmagnetic metal layers 90 and the bias magnetic field applying layer 6. The insulating refill layer 7 is formed of an insulating material such as alumina.

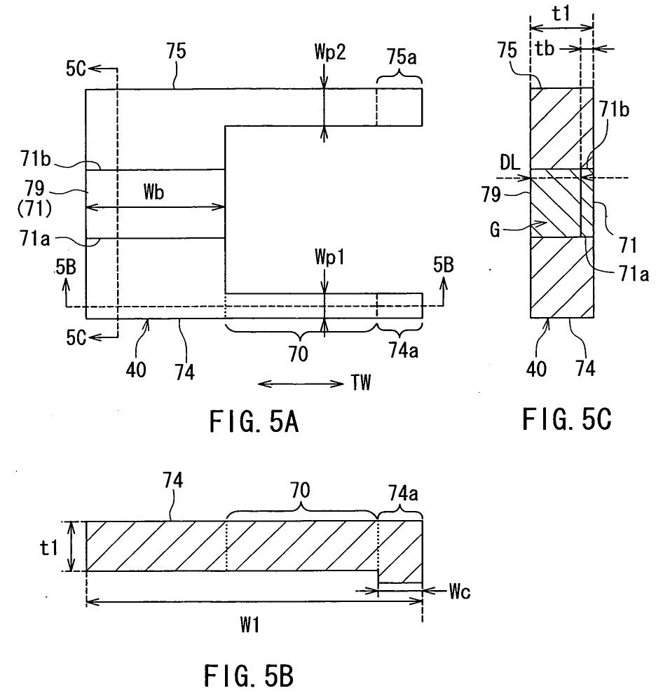

A brief description will now be made on the configuration of the first read shield portion 3 with reference to FIG. 1, and thereafter a detailed description will be made on the configuration of the first read shield portion 3 with reference to FIG. 5A to FIG. 7C. As shown in FIG. 1, the first read shield portion 3 includes: a first shield bias magnetic field applying layer 71 that generates a first shield bias magnetic field; a first closed-magnetic-path-forming portion 72 that forms a first closed magnetic path P1 in conjunction with the first shield bias magnetic field applying layer 71; a first separating layer 73; and a nonmagnetic layer 79. The first shield bias magnetic field applying layer 71 has a magnetization directed to a direction B1 perpendicular to the medium facing surface 40. The first closed-magnetic-path-forming portion 72 includes a first single magnetic domain portion 70 that is brought into a single magnetic domain state such that the magnetization thereof is directed to a first direction D1 by a magnetic flux generated by the first shield bias magnetic field and passing through the first closed magnetic path P1.

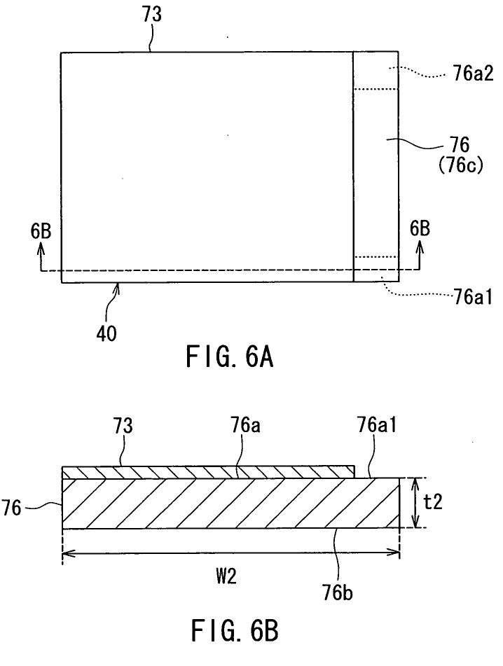

The first closed-magnetic-path-forming potion 72 includes a first portion 74, a second portion 75, and a first magnetic-path-expanding portion 76. The first portion 74 and the second portion 75 are connected to the first shield bias magnetic field applying layer 71. The first portion 74 includes the first single magnetic domain portion 70. As will be shown later in FIG. 6B, the first magnetic-path-expanding portion 76 is rectangular-solid-shaped, and is formed of a magnetic layer having a top surface 76a and a bottom surface 76b that face toward opposite directions. The first magnetic-path-expanding portion 76 is disposed to overlap the first portion 74 and the second portion 75 as seen in a direction perpendicular to the top surface 76a and the bottom surface 76b. The first separating layer 73 is disposed on the top surface 76a of the first magnetic-path-expanding portion 76 such that a portion of the top surface 76a is exposed. The first shield bias magnetic field applying layer 71 is disposed on the first separating layer 73. Major portions of the first and second portions 74 and 75 are disposed on the first separating layer 73, and the other portions 74a and 75a of the first and second portions 74 and 75 are not disposed on the first separating layer 73 but disposed on the top surface 76a of the first magnetic-path-expanding portion 76. The nonmagnetic layer 79 is disposed on the first shield bias magnetic field applying layer 71.

The first shield bias magnetic field applying layer 71 may be formed of a hard magnetic material (permanent magnet material) such as CoPt or CoCrPt, or may be composed of a stack of a ferromagnetic layer and an antiferromagnetic layer. The first portion 74, the second portion 75 and the first magnetic-path-expanding portion 76 are each formed of a soft magnetic material such as such as NiFe, CoFe, CoFeB, CoFeNi or FeN. The first portion 74, the second portion 75 and the first magnetic-path-expanding portion 76 each function as a shield to absorb an unwanted magnetic flux. The first separating layer 73 is formed of a nonmagnetic material. The nonmagnetic material to form the first separating layer 73 may be either insulating or conductive. In the case of feeding a sense current to the MR stack 5 through the first read shield portion 3, it is preferred that the material of the first separating layer 73 be conductive. The nonmagnetic layer 79 is formed of a nonmagnetic material. The nonmagnetic material to form the nonmagnetic layer 79 may be either insulating or conductive.

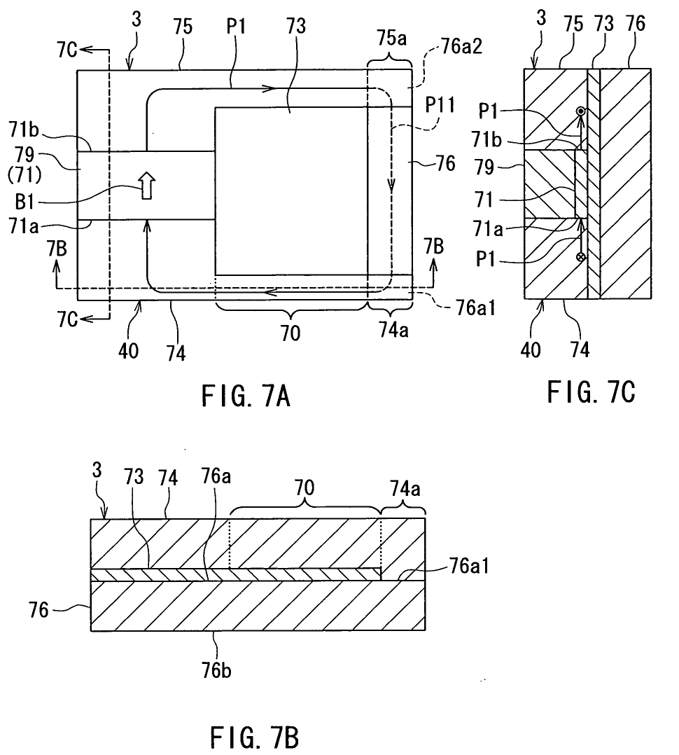

The configuration of the first read shield portion 3 will now be described in detail with reference to FIG. 5A to FIG. 7C. FIG. 5A to FIG. 5C show the first shield bias magnetic field applying layer 71, the first portion 74 and the second portion 75. FIG. 6A to FIG. 6C show the first magnetic-path-expanding portion 76 and the first separating layer 73. FIG. 7A to FIG. 7C show the entire first read shield portion 3.

Reference is first made to FIG. 7A to FIG. 7C to describe the first read shield portion 3 as a whole. FIG. 7A is a plan view of the first read shield portion 3. FIG. 7B is a cross-sectional view of the first read shield portion 3 of FIG. 7A taken along line 7B-7B. FIG. 7C is a cross-sectional view of the first read shield portion 3 of FIG. 7A taken along line 7C-7C. The first read shield portion 3 is formed by providing the first shield bias magnetic field applying layer 71, the first portion 74, the second portion 75 and the nonmagnetic layer 79 shown in FIG. 5A to FIG. 5C on the first magnetic-path-expanding portion 76 and the first separating layer 73 shown in FIG. 6A and FIG. 6B.

Reference is now made to FIG. 5A to FIG. 5C to describe the first shield bias magnetic field applying layer 71, the first portion 74 and the second portion 75. FIG. 5A is a plan view of a part of the first read shield portion 3. FIG. 5B is a cross-sectional view of the part of the first read shield portion 3 of FIG. 5A taken along line 5B-5B. FIG. 5C is a cross-sectional view of the part of the first read shield portion 3 of FIG. 5A taken along line 5C-5C.

As shown in FIG. 5A and FIG. 5C, the first shield bias magnetic field applying layer 71 is disposed away from the medium facing surface 40. The first shield bias magnetic field applying layer 71 has a first end 71a and a second end 71b that are opposite ends of the layer 71 in the direction perpendicular to the medium facing surface 40. The first end 71a is located closer to the medium facing surface 40 than is the second end 71b. The first portion 74 is connected to the first end 71a, and the second portion 75 is connected to the second end 71b.

As shown in FIG. 5A, the first portion 74A initially extends from the portion connected to the first end 71a toward the medium facing surface 40, and then turns to extend parallel to the track width direction (the horizontal direction in FIG. 5A) toward the right in FIG. 5A. The first single magnetic domain portion 70 is part of the first portion 74 and extends parallel to the track width direction. As shown in FIG. 1, FIG. 7A and FIG. 7B, the portion 74a, which is located closer to the extremity of the first portion 74 than is the first single magnetic domain portion 70 (or in other words, located to the right of the first single magnetic domain portion 70 in FIG. 5A), is not disposed on the first separating layer 73. The bottom surface of this extremity portion 74a is located at a lower level than the bottom surface of the remainder of the first portion 74, thereby touching the top surface 76a of the first magnetic-path-expanding portion 76, as shown in FIG. 7B. The remainder of the first portion 74 is disposed on the first separating layer 73. The second portion 75 initially extends from the portion connected to the second end 71b toward the direction away from the medium facing surface 40, and then turns to extend parallel to the track width direction (the horizontal direction in FIG. 5A) toward the right in FIG. 5A. As shown in FIG. 1 and FIG. 7A, the extremity portion 75a (the portion close to the right end in FIG. 5A) of the second portion 75 is not disposed on the first separating layer 73. The bottom surface of the extremity portion 75a is located at a lower level than the bottom surface of the remainder of the second portion 75, thereby touching the top surface 76a of the first magnetic-path-expanding portion 76. The remainder of the second portion 75 is disposed on the first separating layer 73.

Here, as shown in FIG. 5B and FIG. 5C, the thickness of the portion of each of the first and second portions 74 and 75 disposed on the first separating layer 73 is designated as t1. As shown in FIG. 5C, the thickness of the first shield bias magnetic field applying layer 71 is designated as tb. For each component of the first read shield portion 3 and the second read shield portion 8, the “thickness” refers to the dimension of the component taken in the direction perpendicular to the top surface of the substrate 1. In the present embodiment, as shown in FIG. 5C, the thickness tb of the first shield bias magnetic field applying layer 71 is smaller than the thickness t1 of the portion of each of the first and second portions 74 and 75 disposed on the first separating layer 73. Consequently, there is a difference in level DL between the top surface of the first shield bias magnetic field applying layer 71 and the top surface of each of the first and second portions 74 and 75 such that the top surface of the first shield bias magnetic field applying layer 71 is located at a lower level. The nonmagnetic layer 79 is provided to fill the gap G resulting from this difference in level DL so that the top surface of the nonmagnetic layer 79 is located at the same level as the top surface of each of the first and second portions 74 and 75. Although not shown in FIG. 1, the nonmagnetic layer 79 also covers a portion of the top surface 76a of the first magnetic-path-expanding portion 76 and a portion of the top surface of the first separating layer 73 that are not covered with any of the first shield bias magnetic field applying layer 71, the first portion 74 and the second portion 75. Consequently, the entire top surface of the first read shield portion 3 is flat.

As shown in FIG. 5A, the dimension of the first shield bias magnetic field applying layer 71 taken in the track width direction is designated as Wb, the dimension of the first portion 74 taken in the direction perpendicular to the medium facing surface 40 is designated as Wp1, and the dimension of the second portion 75 taken in the direction perpendicular to the medium facing surface 40 is designated as Wp2. As shown in FIG. 5A, the dimensions of the first and second portions 74 and 75 taken in the track width direction are equal. As shown in FIG. 5B, the dimension of each of the first and second portions 74 and 75 taken in the track width direction is designated as W1. The portion of the bottom surface of the first portion 74 touching the top surface 76a of the first magnetic-path-expanding portion 76 and the portion of the bottom surface of the second portion 75 touching the top surface 76a of the first magnetic-path-expanding portion 76 are equal in dimension taken in the track width direction. This dimension is designated as Wc, as shown in FIG. 5B.

Reference is now made to FIG. 6A and FIG. 6B to describe the first magnetic-path-expanding portion 76 and the first separating layer 73. FIG. 6A is a plan view showing the first magnetic-path-expanding portion 76 and the first separating layer 73. FIG. 6B is a cross-sectional view of the first magnetic-path-expanding portion 76 and the first separating layer 73 of FIG. 6A taken along line 6B-6B. As previously mentioned, the first magnetic-path-expanding portion 76 is rectangular-solid-shaped, and is formed of a magnetic layer having the top surface 76a and the bottom surface 76b that face toward opposite directions. The first separating layer 73 is disposed on the top surface 76a of the first magnetic-path-expanding portion 76 such that a portion of the top surface 76a is exposed. Here, as shown in FIG. 6B, the dimension of the first magnetic-path-expanding portion 76 taken in the track width direction is designated as W2, and the thickness of the first magnetic-path-expanding portion 76 is designated as t2.

As shown in FIG. 1, the first magnetic-path-expanding portion 76 forms a first magnetic path P11 that is a portion of the first closed magnetic path P1 and located between the first shield bias magnetic field applying layer 71 and the first single magnetic domain portion 70. As shown in FIG. 6A, the first magnetic-path-expanding portion 76 has two end portions 76a1 and 76a2 located at both ends of the first magnetic path P11, and a middle portion 76c located between the two end portions. In the present embodiment, the two end portions 76a1 and 76a2 of the first magnetic-path-expanding portion 76 are included in the top surface 76a of the first magnetic-path-expanding portion 76. Specifically, the end portion 76a1 is a portion of the top surface 76a touching the first portion 74, and the end portion 76a2 is a portion of the top surface 76a touching the second portion 75. The middle portion 76c is a portion of the first magnetic-path-expanding portion 76 other than the two end portions 76a1 and 76a2. The dimension of each of the end portions 76a1 and 76a2 taken in the track width direction is equal to Wc shown in FIG. 5B.

A cross section of the first magnetic path P11 at the middle portion 76c is greater in width than a cross section of the first magnetic path P11 at each of the two end portions 76a1 and 76a2, the width being taken in a direction parallel to the top surface 76a and the bottom surface 76b. Note that a cross section of a magnetic path refers to a cross section of the magnetic path perpendicular to the magnetic flux. The width of the cross section of the first magnetic path P11 at each of the two end portions 76a1 and 76a2, as taken in the direction parallel to the top surface 76a and the bottom surface 76b, is Wc. The width of the cross section of the first magnetic path P11 at the middle portion 76c, as taken in the direction parallel to the top surface 76a and the bottom surface 76b, is W2. Wc is preferably 1.2 to 2 times greater than Wp1. W2 is greater than Wc. Preferably, t2 is equal to or greater than t1.

Again, the first read shield portion 3 as a whole will now be described with reference to FIG. 7A to FIG. 7C. The end portion 76a1 of the first magnetic-path-expanding portion 76 is connected to the first portion 74 so that a magnetic path passing through the first single magnetic domain portion 70 is formed between the end portion 76a1 and the first end 71a of the first shield bias magnetic field applying layer 71. The end portion 76a2 of the first magnetic-path-expanding portion 76 is connected to the second portion 75. The first separating layer 73 is disposed between the top surface 76a of the first magnetic-path-expanding portion 76 except the two end portions 76a1 and 76a2 and each of the first and second portions 74 and 75, and magnetically separates the first and second portions 74 and 75 from the first magnetic-path-expanding portion 76 except the two end portions 76a1 and 76a2.

In FIG. 1 and FIG. 7A the first closed magnetic path P1 is shown as a line starting from the second end 71b (not shown in FIG. 1) of the first shield bias magnetic field applying layer 71 and terminating at the first end 71a (not shown in FIG. 1) of the first shield bias magnetic field applying layer 71. With reference to this line, the first closed magnetic path P1 is a magnetic path starting from the second end 71b of the first shield bias magnetic field applying layer 71, passing in succession through the second portion 75, the end portion 76a2 of the first magnetic-path-expanding portion 76, the middle portion 76c of the first magnetic-path-expanding portion 76, the end portion 76a1 of the first magnetic-path-expanding portion 76 and the first portion 74 (including the first single magnetic domain portion 70), and reaching the first end 71a of the first shield bias magnetic field applying layer 71.

In the first read shield portion 3, the first shield bias magnetic field generated by the first shield bias magnetic field applying layer 71 generates a magnetic flux passing through the first closed magnetic path P1. This magnetic flux passes through the first single magnetic domain portion 70 that extends in the track width direction. This magnetic flux brings the first single magnetic domain portion 70 into a single magnetic domain state such that the magnetization thereof is directed to the first direction D1.

In the first read shield portion 3, the first closed-magnetic-path-forming portion 72 includes the first magnetic-path-expanding portion 76, and this allows the first closed-magnetic-path-forming portion 72 to be magnetically stable. As a result, it becomes possible to suppress the occurrence of an abrupt change in output of the MR element. This will be described in detail later.

In the example shown in FIG. 5A to FIG. 7C, the first separating layer 73 is disposed on the flat top surface 76a of the first magnetic-path-expanding portion 76, and the respective bottom surfaces of the extremity portions 74a and 75a of the first and second portions 74 and 75 project downward and thereby touch the top surface 76a of the first magnetic-path-expanding portion 76. This configuration may be replaced with a configuration in which: the top surface 76a of the first magnetic-path-expanding portion 76 is provided with a recess; the first separating layer 73 is accommodated in the recess; the top surface 76a of the first magnetic-path-expanding portion 76 and the top surface of the first separating layer 73 are flattened; and the first portion 74 and the second portion 75 each having a flat bottom surface are disposed on the top surfaces of the first magnetic-path-expanding portion 76 and the first separating layer 73. In this case, it becomes possible to form the first portion 74 and the second portion 75 with accuracy.

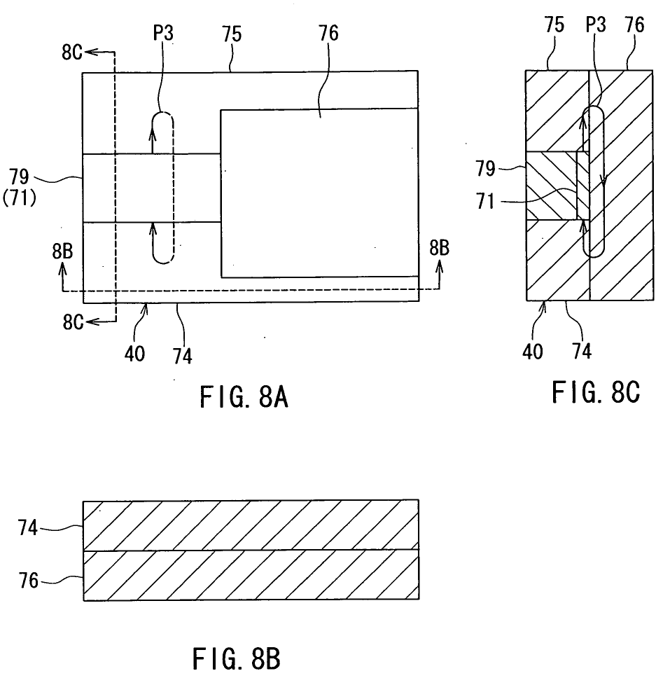

The function of the first separating layer 73 of the first read shield portion 3 will now be described. First, a read shield portion of a comparative example without the first separating layer 73 as shown in FIG. 8A to FIG. 8C will be considered. FIG. 8A is a plan view of the read shield portion of the comparative example. FIG. 8B is a cross-sectional view of the read shield portion of the comparative example of FIG. 8A taken along line 8B-8B. FIG. 8C is a cross-sectional view of the read shield portion of the comparative example of FIG. 8A taken along line 8C-8C. In the read shield portion of this comparative example, the first separating layer 73 is not provided, so that the entire bottom surfaces of the first portion 74 and the second portion 75 touch the top surface 76a of the first magnetic-path-expanding portion 76. The remainder of configuration of the read shield portion of the comparative example is the same as that of the first read shield portion 3.

Each of FIG. 8A and FIG. 8C shows a closed magnetic path P3 passing through the first portion 74, the second portion 75 and the first magnetic-path-expanding portion 76. In the read shield portion of the comparative example, the top surface 76a of the first magnetic-path-expanding portion 76 touches the first portion 74 and the second portion 75 in the vicinity of the first shield bias magnetic field applying layer 71. Consequently, most part of the magnetic flux produced by the first shield bias magnetic field passes through the first portion 74, the second portion 75 and the first magnetic-path-expanding portion 76 in the vicinity of the first shield bias magnetic field applying layer 71. As a result, the magnetic flux passing through the first single magnetic domain portion 70 is greatly reduced, and thus becomes unable to bring the first single magnetic domain portion 70 into a single magnetic domain state.

In contrast, according to the present embodiment, the first separating layer 73 is disposed between the top surface 76a of the first magnetic-path-expanding portion 76 except the two end portions 76a1 and 76a2 and each of the first portion 74 and the second portion 75, and magnetically separates the first and second portions 74 and 75 from the first magnetic-path-expanding portion 76 except the two end portions 76a1 and 76a2. This serves to reduce the magnetic flux passing through the first portion 74, the second portion 75 and the first magnetic-path-expanding portion 76 in the vicinity of the first shield bias magnetic field applying layer 71, and thereby makes it possible to efficiently guide the magnetic flux into the first single magnetic domain portion 70 through the first magnetic-path-expanding portion 76. As a result, according to the present embodiment, it is possible to efficiently bring the first single magnetic domain portion 70 into a single magnetic domain state.

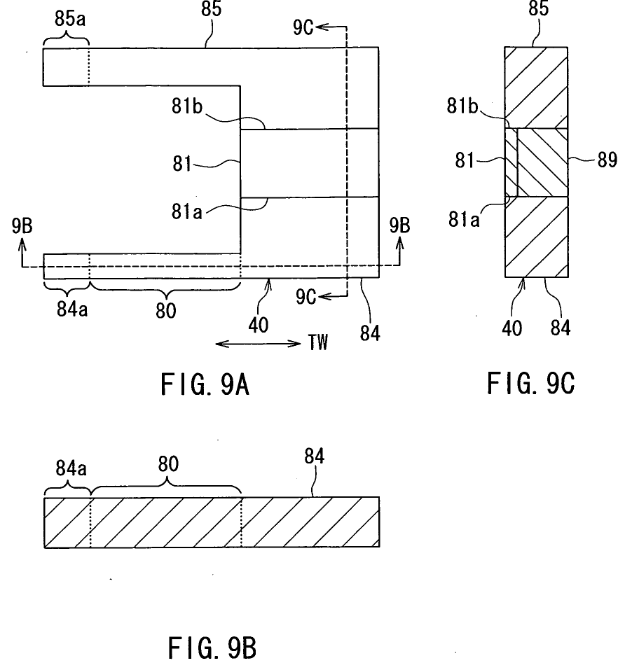

A brief description will now be made on the configuration of the second read shield portion 8 with reference to FIG. 1, and thereafter a detailed description will be made on the configuration of the second read shield portion 8 with reference to FIG. 9A to FIG. 11C. The second read shield portion 8 has components similar to those of the first read shield portion 3. Relative positions of the components of the first read shield portion 3 and the components of the second read shield portion 8 are almost symmetrical with each other with respect to a line that passes through the vertical and horizontal center of the MR stack 5 and that is perpendicular to the medium facing surface 40. In the case where a recess is formed in the top surface 76a of the first magnetic-path-expanding portion 76 of the first read shield portion 3 and the first separating layer 73 is accommodated in this recess, relative positions of the components of the first read shield portion 3 and the components of the second read shield portion 8 become completely symmetrical with each other with respect to a line that passes through the vertical and horizontal center of the MR stack 5 and that is perpendicular to the medium facing surface 40.

As shown in FIG. 1, the second read shield portion 8 includes: a second shield bias magnetic field applying layer 81 that generates a second shield bias magnetic field; a second closed-magnetic-path-forming portion 82 that forms a second closed magnetic path (not shown) in conjunction with the second shield bias magnetic field applying layer 81; a second separating layer 83; and a nonmagnetic layer 89. The second shield bias magnetic field applying layer 81 has a magnetization directed to a direction that is perpendicular to the medium facing surface 40 and the same as the direction of the magnetization of the first shield bias magnetic field applying layer 71. The second closed-magnetic-path-forming portion 82 includes a second single magnetic domain portion 80 that is brought into a single magnetic domain state such that the magnetization thereof is directed to a second direction D2 by a magnetic flux generated by the second shield bias magnetic field and passing through the second closed magnetic path. The first direction D1 and the second direction D2 are each parallel to the track width direction TW and are antiparallel to each other.

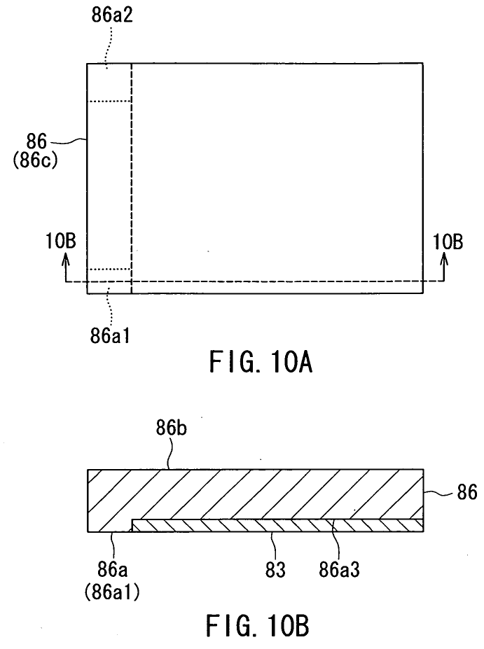

The second closed-magnetic-path-forming potion 82 includes a first portion 84, a second portion 85, and a second magnetic-path-expanding portion 86. The first portion 84 and the second portion 85 are connected to the second shield bias magnetic field applying layer 81. The first portion 84 includes the second single magnetic domain portion 80. As will be shown later in FIG. 10B, the second magnetic-path-expanding portion 86 is rectangular-solid-shaped, and is formed of a magnetic layer having a bottom surface 86a and a top surface 86b that face toward opposite directions. The second magnetic-path-expanding portion 86 is disposed to overlap the first portion 84 and the second portion 85 as seen in a direction perpendicular to the bottom surface 86a and the top surface 86b. A recess 86a3 is formed in the bottom surface 86a of the second magnetic-path-expanding portion 86, and the second separating layer 83 is accommodated in this recess 86a3. The bottom surface 86a of the second magnetic-path-expanding portion 86 except the recess 86a3 is not covered with the second separating layer 83. The structure formed by the combination of the second magnetic-path-expanding portion 86 and the second separating layer 83 is rectangular-solid-shaped. The second shield bias magnetic field applying layer 81 is disposed below the second separating layer 83. Major portions of the first and second portions 84 and 85 are disposed below the second separating layer 83, and the other portions 84a and 85a of the first and second portions 84 and 85 are not disposed below the second separating layer 83 but disposed below a portion of the bottom surface 86a of the second magnetic-path-expanding portion 86 other than the recess. The nonmagnetic layer 89 is disposed below the second shield bias magnetic field applying layer 81.

Materials used for the second shield bias magnetic field applying layer 81, the second separating layer 83, the first portion 84, the second portion 85, the second magnetic-path-expanding portion 86 and the nonmagnetic layer 89 are the same as those used for the first shield bias magnetic field applying layer 71, the first separating layer 73, the first portion 74, the second portion 75, the first magnetic-path-expanding portion 76 and the nonmagnetic layer 79, respectively, of the first read shield portion 3. Each of the first portion 84, the second portion 85 and the second magnetic-path-expanding portion 86 functions as a shield to absorb an unwanted magnetic flux.

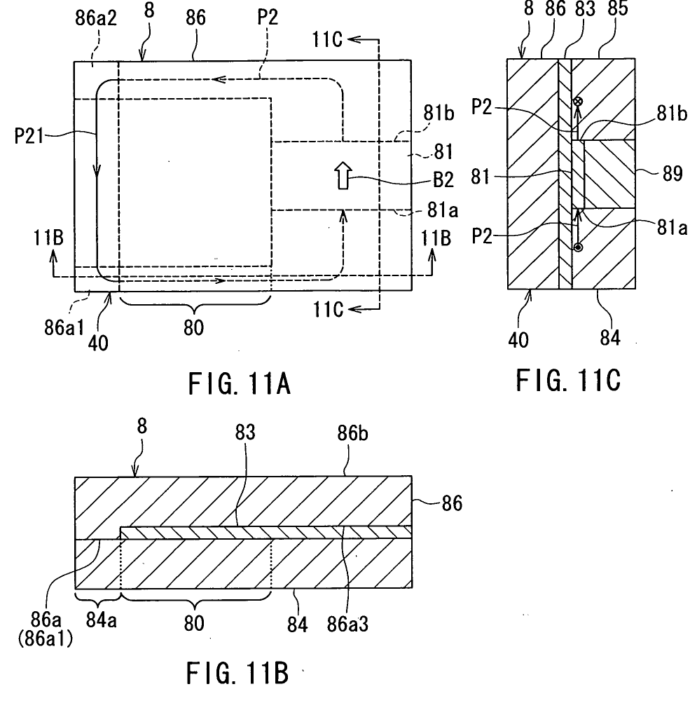

The configuration of the second read shield portion 8 will now be described in detail with reference to FIG. 9A to FIG. 11C. FIG. 9A to FIG. 9C show the second shield bias magnetic field applying layer 81, the first portion 84 and the second portion 85. FIG. 10A and FIG. 10B show the second magnetic-path-expanding portion 86 and the second separating layer 83. FIG. 11A to FIG. 11C show the entire second read shield portion 8.

Reference is first made to FIG. 11A to FIG. 11C to describe the second read shield portion 8 as a whole. FIG. 11A is a plan view of the second read shield portion 8. FIG. 11B is a cross-sectional view of the second read shield portion 8 of FIG. 1A taken along line 11B-11B. FIG. 11C is a cross-sectional view of the second read shield portion 8 of FIG. 11A taken along line 11C-11C. The second read shield portion 8 is formed by providing the second separating layer 83 and the second magnetic-path-expanding portion 86 shown in FIG. 10A and FIG. 10B on the second shield bias magnetic field applying layer 81, the first portion 84, the second portion 85 and the nonmagnetic layer 89 shown in FIG. 9A to FIG. 9C.

Reference is now made to FIG. 9A to FIG. 9C to describe the second shield bias magnetic field applying layer 81, the first portion 84 and the second portion 85. FIG. 9A is a plan view of a part of the second read shield portion 8. FIG. 9B is a cross-sectional view of the part of the second read shield portion 8 of FIG. 9A taken along line 9B-9B. FIG. 9C is a cross-sectional view of the part of the second read shield portion 8 of FIG. 9A taken along line 9C-9C.

As shown in FIG. 9A and FIG. 9C, the second shield bias magnetic field applying layer 81 is disposed away from the medium facing surface 40. The second shield bias magnetic field applying layer 81 has a first end 81a and a second end 81b that are opposite ends of the layer 81 in the direction perpendicular to the medium facing surface 40. The first end 81a is located closer to the medium facing surface 40 than is the second end 81b. The first portion 84 is connected to the first end 81a, and the second portion 85 is connected to the second end 81b.

As shown in FIG. 9A, the first portion 84A initially extends from the portion connected to the first end 81a toward the medium facing surface 40, and then turns to extend parallel to the track width direction (the horizontal direction in FIG. 9A) toward the left in FIG. 9A. The second single magnetic domain portion 80 is part of the first portion 84 and extends parallel to the track width direction. As shown in FIG. 1, FIG. 11A and FIG. 11B, the portion 84a, which is located closer to the extremity of the first portion 84 than is the second single magnetic domain portion 80 (or in other words, located to the left of the second single magnetic domain portion 80 in FIG. 9A), is not disposed below the second separating layer 83. The top surface of this extremity portion 84a touches the bottom surface 86a of the second magnetic-path-expanding portion 86, as shown in FIG. 11B. The remainder of the first portion 84 is disposed below the second separating layer 83. The second portion 85 initially extends from the portion connected to the second end 81b toward the direction away from the medium facing surface 40, and then turns to extend parallel to the track width direction (the horizontal direction in FIG. 9A) toward the left in FIG. 9A. The extremity portion 85a (the portion close to the left end in FIG. 9A) of the second portion 85 is not disposed below the second separating layer 83. The top surface of the extremity portion 85a touches the bottom surface 86a of the second magnetic-path-expanding portion 86. The remainder of the second portion 85 is disposed below the second separating layer 83.

The thickness of each of the first portion 84 and the second portion 85 is equal to the thickness t1 shown in FIG. 5B. The thickness of the second shield bias magnetic field applying layer 81 is equal to the thickness tb of the first shield bias magnetic field applying layer 71 shown in FIG. 5C. As shown in FIG. 9C, the second shield bias magnetic field applying layer 81 is disposed on the nonmagnetic layer 89. Although not shown, the nonmagnetic layer 89 is also present in the space surrounded by the second shield bias magnetic field applying layer 81, the first portion 84 and the second portion 85 shown in FIG. 9A. Consequently, the top surfaces of the second shield bias magnetic field applying layer 81, the first portion 84, the second portion 85 and the nonmagnetic layer 89 are flat.

The dimension of the second shield bias magnetic field applying layer 81 taken in the track width direction is equal to the dimension Wb of the first shield bias magnetic field applying layer 71 taken in the track width direction shown in FIG. 5A. The dimension of the first portion 84 taken in the direction perpendicular to the medium facing surface 40 is equal to the dimension Wp1 of the first portion 74 taken in the direction perpendicular to the medium facing surface 40 shown in FIG. 5A. The dimension of the second portion 85 taken in the direction perpendicular to the medium facing surface 40 is equal to the dimension Wp2 of the second portion 75 taken in the direction perpendicular to the medium facing surface 40 shown in FIG. 5A. The dimension of each of the first and second portions 84 and 85 taken in the track width direction is equal to the dimension W1 of each of the first and second portions 74 and 75 taken in the track width direction shown in FIG. 5B.

Reference is now made to FIG. 10A and FIG. 10B to describe the second magnetic-path-expanding portion 86 and the second separating layer 83. FIG. 10A is a plan view showing the second magnetic-path-expanding portion 86 and the second separating layer 83. FIG. 10B is a cross-sectional view of the second magnetic-path-expanding portion 86 and the second separating layer 83 of FIG. 10A taken along line 10B-10B. As previously mentioned, the second magnetic-path-expanding portion 86 is rectangular-solid-shaped, and is formed of a magnetic layer having the bottom surface 86a and the top surface 86b that face toward opposite directions. A recess is formed in the bottom surface 86a, and the second separating layer 83 is accommodated in this recess. The bottom surface 86a of the second magnetic-path-expanding portion 86 except the recess is not covered with the second separating layer 83. The structure formed by the combination of the second magnetic-path-expanding portion 86 and the second separating layer 83 is rectangular-solid-shaped. The dimension of the second magnetic-path-expanding portion 86 taken in the track width direction is equal to the dimension W2 of the first magnetic-path-expanding portion 76 taken in the track width direction shown in FIG. 6B. The thickness of the portion of the second magnetic-path-expanding portion 86 having the recess in the bottom surface 86a is equal to the thickness t2 of the first magnetic-path-expanding portion 76 shown in FIG. 6B.

The second magnetic-path-expanding portion 86 forms a second magnetic path P21 (see FIG. 11A) that is a portion of the second closed magnetic path P2 (see FIG. 11A) and located between the second shield bias magnetic field applying layer 81 and the second single magnetic domain portion 80. As shown in FIG. 10A, the second magnetic-path-expanding portion 86 has two end portions 86a1 and 86a2 located at both ends of the second magnetic path, and a middle portion 86c located between the two end portions. In the present embodiment, the two end portions 86a1 and 86a2 of the second magnetic-path-expanding portion 86 are included in the bottom surface 86a of the second magnetic-path-expanding portion 86. Specifically, the end portion 86a1 is a portion of the bottom surface 86a touching the first portion 84, and the end portion 86a2 is a portion of the bottom surface 86a touching the second portion 85. The middle portion 86c is a portion of the second magnetic-path-expanding portion 86 other than the two end portions 86a1 and 86a2. The dimension of each of the end portions 86a1 and 86a2 of the second magnetic-path-expanding portion 86 taken in the track width direction is equal to the dimension Wc of each of the end portions 76a1 and 76a2 of the first magnetic-path-expanding portion 76 taken in the track width direction.

A cross section of the second magnetic path P21 at the middle portion 86c is greater in width than a cross section of the second magnetic path P21 at each of the two end portions 86a1 and 86a2, the width being taken in a direction parallel to the bottom surface 86a and the top surface 86b. The width of the cross section of the second magnetic path P21 at each of the two end portions 86a1 and 86a2, as taken in the direction parallel to the bottom surface 86a and the top surface 86b, is equal to Wc shown in FIG. 5B. The width of the cross section of the second magnetic path P21 at the middle portion 86c, as taken in the direction parallel to the bottom surface 86a and the top surface 86b, is equal to W2 shown in FIG. 6B.

Again, the second read shield portion 8 as a whole will now be described with reference to FIG. 11A to FIG. 11C. The end portion 86a1 of the second magnetic-path-expanding portion 86 is connected to the first portion 84 so that a magnetic path passing through the second single magnetic domain portion 80 is formed between the end portion 86a1 and the first end 81a of the second shield bias magnetic field applying layer 81. The end portion 86a2 of the second magnetic-path-expanding portion 86 is connected to the second portion 85. The second separating layer 83 is disposed between the bottom surface 86a of the second magnetic-path-expanding portion 86 except the two end portions 86a1 and 86a2 and each of the first and second portions 84 and 85, and magnetically separates the first and second portions 84 and 85 from the second magnetic-path-expanding portion 86 except the two end portions 86a1 and 86a2.

The second shield bias magnetic field applying layer 81 has a magnetization directed to a direction B2 perpendicular to the medium facing surface 40. The direction B2 of the magnetization of the second shield bias magnetic field applying layer 81 is the same direction as the direction B1 of the magnetization of the first shield bias magnetic field applying layer 71.

In FIG. 11A the second closed magnetic path P2 is shown as a line starting from the second end 81b of the second shield bias magnetic field applying layer 81 and terminating at the first end 81a of the second shield bias magnetic field applying layer 81. With reference to this line, the second closed magnetic path P2 is a magnetic path starting from the second end 81b of the second shield bias magnetic field applying layer 81, passing in succession through the second portion 85, the end portion 86a2 of the second magnetic-path-expanding portion 86, the middle portion 86c of the second magnetic-path-expanding portion 86, the end portion 86a1 of the second magnetic-path-expanding portion 86 and the first portion 84 (including the second single magnetic domain portion 80), and reaching the first end 81a of the second shield bias magnetic field applying layer 81.

In the second read shield portion 8, the second shield bias magnetic field generated by the second shield bias magnetic field applying layer 81 generates a magnetic flux passing through the second closed magnetic path P2. This magnetic flux passes through the second single magnetic domain portion 80 that extends in the track width direction. This magnetic flux brings the second single magnetic domain portion 80 into a single magnetic domain state such that the magnetization thereof is directed to the second direction D2.

In the second read shield portion 8, the second closed-magnetic-path-forming portion 82 includes the second magnetic-path-expanding portion 86, and this allows the second closed-magnetic-path-forming portion 82 to be magnetically stable. As a result, it becomes possible to suppress the occurrence of an abrupt change in output of the MR element. This will be described in detail later.

As shown in FIG. 1, the first single magnetic domain portion 70, the second single magnetic domain portion 80 and the MR stack 5 are disposed such that the MR stack 5 are sandwiched between the first and second single magnetic domain portions 70 and 80.

As shown in FIG. 4, the MR stack 5 includes a first ferromagnetic layer 52, a second ferromagnetic layer 54, and a spacer layer 53 made of a nonmagnetic material and disposed between the ferromagnetic layers 52 and 54. Each of the ferromagnetic layers 52 and 54 is a ferromagnetic layer. The MR stack 5 further includes a first coupling layer 51 disposed between the first single magnetic domain portion 70 and the first ferromagnetic layer 52, and a second coupling layer 55 disposed between the second ferromagnetic layer 54 and the second single magnetic domain portion 80.

Table 1 shows the configuration of the main part of the MR element shown in FIG. 2 and FIG. 4.

TABLE 1
Configuration of MR element

| 2nd read shield | 2nd magnetic-path-expanding portion 86 | |
|---|---|---|
| portion 8 | 2nd separating layer 83 | |
| | 2nd single magnetic domain portion 80 | |
| MR stack 5 | 2nd | Nonmagnetic conductive layer 55c |
| | coupling | Magnetic layer 55b |
| | layer 55 | Nonmagnetic conductive layer 55a |

| 2nd ferromagnetic layer 54 | |
|---|---|
| Spacer layer 53 | |
| 1st ferromagnetic layer 52 | |
| 1st | Nonmagnetic conductive layer 51c |
| coupling | Magnetic layer 51b |
| layer 51 | Nonmagnetic conductive layer 51a |

| | |
|---|---|
| 1st read shield | 1st single magnetic domain portion 70 |
| portion 3 | 1st separating layer 73 |
| | 1st magnetic-path-expanding portion 76 |

The first ferromagnetic layer 52 is magnetically coupled to the first single magnetic domain portion 70. The second ferromagnetic layer 54 is magnetically coupled to the second single magnetic domain portion 80. The first ferromagnetic layer 52 and the second ferromagnetic layer 54 have magnetizations that are in directions antiparallel to each other when any external magnetic field other than a magnetic field resulting from the single magnetic domain portions 70 and 80 is not applied to the first and second ferromagnetic layers 52 and 54, and that change their directions in response to an external magnetic field other than the magnetic field resulting from the single magnetic domain portions 70 and 80. Thus, each of the ferromagnetic layers 52 and 54 functions as a free layer. Each of the ferromagnetic layers 52 and 54 is formed of a ferromagnetic material having a low coercivity, such as NiFe, CoFe, CoFeB, CoFeNi, or FeN. It should be noted that the state in which any external magnetic field other than a magnetic field resulting from the single magnetic domain portions 70 and 80 is not applied to the ferromagnetic layers 52 and 54 is a state in which any bias magnetic field generated by the bias magnetic field applying layer 6 is not applied to the ferromagnetic layers 52 and 54 when there is no magnetic field applied to the MR element from outside the MR element.

In the case where the MR stack 5 is a TMR element, the spacer layer 53 is a tunnel barrier layer. The spacer layer 53 in this case is formed of an insulating material such as alumina, SiO₂ or MgO. In the case where the MR stack 5 is a GMR element of the CPP structure, the spacer layer 53 is a nonmagnetic conductive layer. The spacer layer 53 in this case is formed of, for example, a nonmagnetic conductive material such as Ru, Rh, Ir, Re, Cr, Zr or Cu, or an oxide semiconductor material such as ZnO, In₂O₃ or SnO₂.

The first coupling layer 51 is a layer for magnetically coupling the first ferromagnetic layer 52 to the first single magnetic domain portion 70. The first coupling layer 51 also serves to adjust the distance between the first single magnetic domain portion 70 and the first ferromagnetic layer 52. The first coupling layer 51 includes a nonmagnetic conductive layer 51a, a magnetic layer 51b, and a nonmagnetic conductive layer 51c that are stacked in this order on the first single magnetic domain portion 70. The nonmagnetic conductive layer 51c touches the bottom surface of the first ferromagnetic layer 52. The nonmagnetic conductive layers 51a and 51c are each formed of a nonmagnetic conductive material containing at least one of Ru, Rh, Ir, Cr, Cu, Ag, Au, Pt and Pd, for example. The magnetic layer 51b is formed of a magnetic material such as NiFe, CoFe, CoFeB, CoFeNi or FeN.

The first single magnetic domain portion 70 and the magnetic layer 51b are antiferromagnetically coupled to each other by the RKKY interaction through the nonmagnetic conductive layer 51a. The magnetizations of the first single magnetic domain portion 70 and the magnetic layer 51b are therefore directed antiparallel to each other. The magnetic layer 51b and the first ferromagnetic layer 52 are antiferromagnetically coupled to each other by the RKKY interaction through the nonmagnetic conductive layer 51c. The magnetizations of the magnetic layer 51b and the first ferromagnetic layer 52 are therefore directed antiparallel to each other. As a result, the magnetization of the first ferromagnetic layer 52 is directed to the same direction as the magnetization of the first single magnetic domain portion 70. In this way, the direction of the magnetization of the first ferromagnetic layer 52 is controlled by the first single magnetic domain portion 70.

The second coupling layer 55 is a layer for magnetically coupling the second ferromagnetic layer 54 to the second single magnetic domain portion 80. The second coupling layer 55 also serves to adjust the distance between the second single magnetic domain portion 80 and the second ferromagnetic layer 54. The second coupling layer 55 includes a nonmagnetic conductive layer 55a, a magnetic layer 55b, and a nonmagnetic conductive layer 55c that are stacked in this order on the second ferromagnetic layer 54. The nonmagnetic conductive layer 55c touches the bottom surface of the second single magnetic domain portion 80. The nonmagnetic conductive layers 55a and 55c are each formed of a nonmagnetic conductive material containing at least one of Ru, Rh, Ir, Cr, Cu, Ag, Au, Pt and Pd, for example. The magnetic layer 55b is formed of a magnetic material such as NiFe, CoFe, CoFeB, CoFeNi or FeN.

In the example shown in FIG. 4, the structure of the second coupling layer 55 is vertically symmetrical with the structure of the first coupling layer 51. In this example, each of the coupling layers 51 and 55 includes a magnetic layer, and two nonmagnetic conductive layers sandwiching the magnetic layer. However, the configuration of each of the first and second coupling layers 51 and 55 is not limited to the three-layer configuration shown in FIG. 4. Each of the coupling layers 51 and 55 may be composed of three or more nonmagnetic conductive layers, and magnetic layers disposed between every adjacent two of the nonmagnetic conductive layers, or may be composed of a single nonmagnetic conductive layer only. The first and second coupling layers 51 and 55 may have configurations different from each other. For example, one of the first and second coupling layers 51 and 55 may be composed of a magnetic layer and two nonmagnetic conductive layers sandwiching the magnetic layer, while the other of the first and second coupling layers 51 and 55 may be composed of a single nonmagnetic conductive layer only.

The second single magnetic domain portion 80 and the magnetic layer 55b are antiferromagnetically coupled to each other by the RKKY interaction through the nonmagnetic conductive layer 55c. The magnetizations of the second single magnetic domain portion 80 and the magnetic layer 55b are therefore directed antiparallel to each other. The magnetic layer 55b and the second ferromagnetic layer 54 are antiferromagnetically coupled to each other by the RKKY interaction through the nonmagnetic conductive layer 55a. The magnetizations of the magnetic layer 55b and the second ferromagnetic layer 54 are therefore directed antiparallel to each other. As a result, the magnetization of the second ferromagnetic layer 54 is directed to the same direction as the magnetization of the second single magnetic domain portion 80. In this way, the direction of the magnetization of the second ferromagnetic layer 54 is controlled by the second single magnetic domain portion 80.

In the present embodiment, since the directions of the magnetizations of the first single magnetic domain portion 70 and the second single magnetic domain portion 80 are antiparallel to each other, the directions of the magnetizations of the first ferromagnetic layer 52 and the second ferromagnetic layer 54 are antiparallel to each other.

As shown in FIG. 3, the bias magnetic field applying layer 6 has a magnetization directed to the direction B3 perpendicular to the medium facing surface 40. The bias magnetic field applying layer 6, the first shield bias magnetic field applying layer 71 and the second shield bias magnetic field applying layer 81 preferably have magnetizations directed to the same direction. The bias magnetic field applying layer 6 applies a bias magnetic field to the ferromagnetic layers 52 and 54 so that the magnetizations of the ferromagnetic layers 52 and 54 change their directions compared with a state in which no bias magnetic field is applied to the ferromagnetic layers 52 and 54. The bias magnetic field applying layer 6 preferably applies a bias magnetic field to the ferromagnetic layers 52 and 54 so that the magnetizations of the ferromagnetic layers 52 and 54 are directed orthogonal to each other.

The MR element of the present embodiment is of the CPP structure. More specifically, a sense current, which is a current used for detecting a signal magnetic field, is fed in a direction intersecting the planes of the layers constituting the MR stack 5, such as the direction perpendicular to the planes of the layers constituting the MR stack 5. The first read shield portion 3 and the second read shield portion 8 also function as a pair of electrodes for feeding the sense current to the MR stack 5 in a direction intersecting the planes of the layers constituting the MR stack 5, such as the direction perpendicular to the planes of the layers constituting the MR stack 5.

A manufacturing method for the MR element of the present embodiment will now be described. In this manufacturing method, first, the first magnetic-path-expanding portion 76 is formed on the insulating layer 2 by, for example, frame plating. Next, the first separating layer 73 is formed on the first magnetic-path-expanding portion 76 by, for example, lift-off. Next, the first portion 74 and the second portion 75 are formed on the first magnetic-path-expanding portion 76 and the first separating layer 73 by, for example, frame plating. Next, the first shield bias magnetic field applying layer 71 is formed by, for example, lift-off. Next, the nonmagnetic layer 79 is formed to cover the first magnetic-path-expanding portion 76, the first separating layer 73, the first portion 74, the second portion 75 and the first shield bias magnetic field applying layer 71 by, for example, sputtering. Next, the nonmagnetic layer 79 is polished by, for example, chemical mechanical polishing (hereinafter referred to as CMP), until the first portion 74 and the second portion 75 become exposed, and the top surfaces of the first portion 74, the second portion 75 and the nonmagnetic layer 79 are thereby flattened.

Next, on the first single magnetic domain portion 70 included in the first portion 74, films to later become the layers constituting MR stack 5 are formed in succession by, for example, sputtering. A layered film for the MR stack 5 is thereby formed. Next, the layered film for the MR stack 5 is selectively etched to form two side surfaces that will later become the two side surfaces of the MR stack 5. Next, an insulating film, which is to become a portion of the insulating film 4 covering the two side surfaces of the MR stack 5 and located below the two nonmagnetic metal layers 90, is formed by, for example, sputtering. Next, the two nonmagnetic metal layers 90 are formed on this insulating film by, for example, sputtering.

Next, the MR stack 5 is formed by selectively etching the layered film for the MR stack 5 such that the rear end face of the MR stack 5 is formed. Next, an insulating film, which is to become a portion of the insulating film 4 covering the rear end face of the MR stack 5 and located below the bias magnetic field applying layer 6, is formed by, for example, sputtering. Next, the bias magnetic field applying layer 6 is formed on this insulating film and the protection layer 61 is formed on the bias magnetic field applying layer 6, each by sputtering, for example. Next, the insulating refill layer 7 is formed by, for example, sputtering.

Next, the first portion 84 and the second portion 85 are formed by, for example, frame plating. Next, a portion of the nonmagnetic layer 89 to be located below the second shield bias magnetic field applying layer 81 and the second shield bias magnetic field applying layer 81 are formed by, for example, lift-off. Next, the remaining portion of the nonmagnetic layer 89 is formed to cover the first portion 84, the second portion 85 and the second shield bias magnetic field applying layer 81 by, for example, sputtering. Next, the nonmagnetic layer 89 is polished by, for example, CMP, until the first portion 84, the second portion 85 and the second shield bias magnetic field applying layer 81 become exposed, and the top surfaces of the first portion 84, the second portion 85 and the nonmagnetic layer 89 are thereby flattened. Next, the second separating layer 83 is formed by, for example, lift-off. Next, the second magnetic-path-expanding portion 86 is formed by, for example, frame plating.

The first and second shield bias magnetic field applying layers 71 and 81 and the bias magnetic field applying layer 6 are subjected to magnetizing so that they have magnetizations in, for example, the same direction.

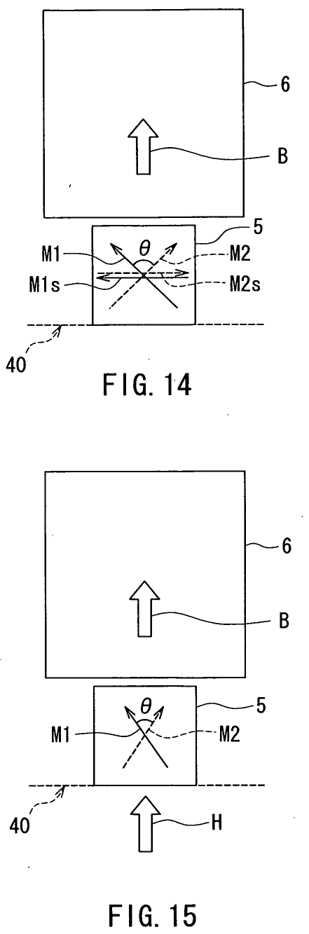

The operation of the MR element of the present embodiment will now be described with reference to FIG. 14 to FIG. 16. Each of FIG. 14 to FIG. 16 shows the MR stack 5 and the bias magnetic field applying layer 6. In FIG. 14 to FIG. 16 the arrow marked with “B” indicates a bias magnetic field generated by the bias magnetic field applying layer 6. The arrow marked with “M1s” indicates the direction of the magnetization of the first ferromagnetic layer 52 when any external magnetic field (including a bias magnetic field) other than a magnetic field resulting from the first and second single magnetic domain portions 70 and 80 is not applied to the first ferromagnetic layer 52. The arrow marked with “M2s” indicates the direction of the magnetization of the second ferromagnetic layer 54 when any external magnetic field described above is not applied to the second ferromagnetic layer 54. The arrow marked with “M1” indicates the direction of the magnetization of the first ferromagnetic layer 52 when the bias magnetic field B is applied to the first ferromagnetic layer 52. The arrow marked with “M2” indicates the direction of the magnetization of the second ferromagnetic layer 54 when the bias magnetic field B is applied to the second ferromagnetic layer 54.

As shown in FIG. 14, when no external magnetic field is applied to the ferromagnetic layers 52 and 54, the directions of the magnetizations of the ferromagnetic layers 52 and 54 are antiparallel to each other. When the bias magnetic field B is applied but no signal magnetic field is applied to the ferromagnetic layers 52 and 54, the directions of the magnetizations of the ferromagnetic layers 52 and 54 become non-antiparallel to each other. When in this state, it is desirable that the direction of the magnetization of the first ferromagnetic layer 52 and the direction of the magnetization of the second ferromagnetic layer 54 each form an angle of 45 degrees with respect to the medium facing surface 40 and the relative angle θ between the directions of the magnetizations of the ferromagnetic layers 52 and 54 be 90 degrees.

FIG. 15 shows a state in which the bias magnetic field B and also a signal magnetic field H in the same direction as the bias magnetic field B are applied to the ferromagnetic layers 52 and 54. When in this state, the angle formed by the direction of the magnetization of the first ferromagnetic layer 52 with respect to the medium facing surface 40 and the angle formed by the direction of the magnetization of the second ferromagnetic layer 54 with respect to the medium facing surface 40 are each greater compared with the state shown in FIG. 14. As a result, the relative angle θ between the directions of the magnetizations of the ferromagnetic layers 52 and 54 is smaller compared with the state shown in FIG. 14.

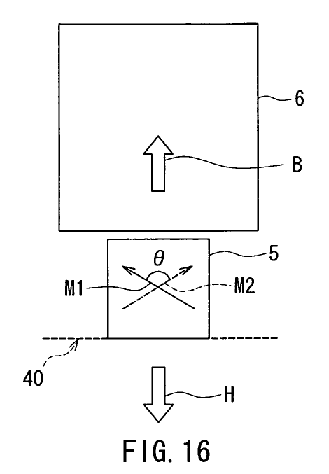

FIG. 16 shows a state in which the bias magnetic field B and also a signal magnetic field H in a direction opposite to the direction of the bias magnetic field B are applied to the ferromagnetic layers 52 and 54. When in this state, the angle formed by the direction of the magnetization of the first ferromagnetic layer 52 with respect to the medium facing surface 40 and the angle formed by the direction of the magnetization of the second ferromagnetic layer 54 with respect to the medium facing surface 40 are each smaller compared with the state shown in FIG. 14. As a result, the relative angle θ between the directions of the magnetizations of the ferromagnetic layers 52 and 54 is greater compared with the state shown in FIG. 14.

The relative angle between the directions of the magnetizations of the ferromagnetic layers 52 and 54 thus changes in response to a signal magnetic field, and as a result, the resistance of the MR stack 5 changes. It is therefore possible to detect the signal magnetic field by detecting the resistance of the MR stack 5. The resistance of the MR stack 5 can be determined from the potential difference produced in the MR stack 5 when a sense current is fed to the MR stack 5. It is thus possible, through the use of the MR element, to read data stored on the recording medium.

Advantageous effects of the MR element of the present embodiment will now be described. In the present embodiment, the magnetizations of the first single magnetic domain portion 70 and the second single magnetic domain portion 80 are directed antiparallel to each other. The first ferromagnetic layer 52 is magnetically coupled to the first single magnetic domain portion 70, and the second ferromagnetic layer 54 is magnetically coupled to the second single magnetic domain portion 80. As a result, the first and second ferromagnetic layers 52 and 54 have magnetizations that are directed antiparallel to each other when any external magnetic field other than a magnetic field resulting from the single magnetic domain portions 70 and 80 is not applied to the first and second ferromagnetic layers 52 and 54. According to the present embodiment, it is thus possible to direct the magnetizations of the two ferromagnetic layers 52 and 54 antiparallel to each other when no external magnetic field is applied, without making use of antiferromagnetic coupling between the two ferromagnetic layers through the spacer layer 53. Consequently, according to the present embodiment, no limitation is imposed on the material and thickness of the spacer layer 53, in contrast to the case of making use of antiferromagnetic coupling between the two free layers.

Furthermore, according to the present embodiment, the first closed-magnetic-path-forming portion 72 includes the first magnetic-path-expanding portion 76, and the second closed-magnetic-path-forming portion 82 includes the second magnetic-path-expanding portion 86. This allows the first and second closed-magnetic-path-forming portions 72 and 82 to be higher in magnetic stability than in the case where long and narrow magnetic paths are provided instead of the magnetic-path-expanding portions 76 and 86. As a result, according to the present embodiment, it is possible to suppress the occurrence of an abrupt change in output of the MR element. This will now be described in detail with reference to experimental results.

In the experiment, 200 MR elements of Example and 200 MR elements of Comparative Example were prepared and their characteristics were investigated. The MR elements of Example each have the configuration of the MR element of the present embodiment. For the MR elements of Example, the first and second portions 74 and 75 and the first magnetic-path-expanding portion 76 of the first closed-magnetic-path-forming portion 72 and the first and second portions 84 and 85 and the second magnetic-path-expanding portion 86 of the second closed-magnetic-path-forming portion 82 were each formed of NiFe and to have a saturation flux density of 1.0 T. Each of the first shield bias magnetic shield applying layer 71 and the second shield bias magnetic field applying layer 81 was formed of CoPt and to have a saturation flux density of 1.2 T and a residual flux density of 1.0 T. Wb was set to 25 μm, tb was set to 0.1 μm, Wp1 was set to 5 μm, and t1 was set to 0.5 μm. Therefore, the product of the residual flux density and the cross-sectional area of the magnetic path in the first shield bias magnetic field applying layer 71 is equal to the product of the saturation flux density and the cross-sectional area of the magnetic path in the first single magnetic domain portion 70. Similarly, the product of the residual flux density and the cross-sectional area of the magnetic path in the second shield bias magnetic field applying layer 81 is equal to the product of the saturation flux density and the cross-sectional area of the magnetic path in the second single magnetic domain portion 80. W1 and W2 were made equal, and t1 and t2 were made equal.

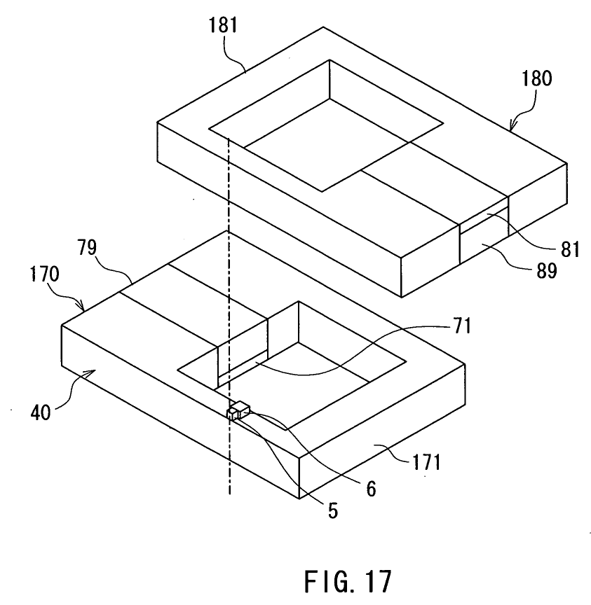

FIG. 17 is a perspective view showing the MR element of Comparative Example. The MR element of Comparative Example has a closed-magnetic-path-forming portion 170 formed of a single magnetic layer, instead of the closed-magnetic-path-forming portion 72 of the MR element of Example, and also has a closed-magnetic-path-forming portion 180 formed of a single magnetic layer, instead of the closed-magnetic-path-forming portion 82 of the MR element of Example. The closed-magnetic-path-forming portion 170 has such a shape that the respective extremity portions of the first and second portions 74 and 75 of the MR element of Example are coupled to each other by a coupling portion 171. The coupling portion 171 extends in the direction perpendicular to the medium facing surface 40. Similarly, the closed-magnetic-path-forming portion 180 has such a shape that the respective extremity portions of the first and second portions 84 and 85 of the MR element of Example are coupled to each other by a coupling portion 181. The coupling portion 181 extends in the direction perpendicular to the medium facing surface 40. The MR element of Comparative Example does not have the magnetic-path-expanding portions 76 and 86 and the separating layers 73 and 83 provided in the MR element of Example. The dimension of each of the coupling portions 171 and 181 taken in the track width direction is equal to Wc shown in FIG. 5B. The remainder of configuration of the MR element of Comparative Example is the same as that of the MR element of Example.

In the MR element of Example, a cross section of the first magnetic path P11 taken at the middle portion 76c is greater in width than a cross section of the first magnetic path P11 at each of the two end portions 76a1 and 76a2, the width being taken in the direction parallel to the top surface 76a and the bottom surface 76b. In addition, a cross section of the second magnetic path P21 at the middle portion 86c is greater in width than a cross section of the second magnetic path P21 at each of the two end portions 86a1 and 86a2, the width being taken in the direction parallel to the bottom surface 86a and the top surface 86b. Furthermore, in the MR element of Example, t1 and t2 are equal. As a result of these conditions, the cross-sectional area of the magnetic path in each of the magnetic-path-expanding portions 76 and 86 is greater than the cross-sectional area of the magnetic path in each of the coupling portions 171 and 181.

In the experiment, a quasi static test was performed on each of the 200 MR elements of Example and 200 MR elements of Comparative Example to investigate the characteristics of the MR elements. In the quasi static test, an alternating magnetic field of −500 Oe to 500 Oe (1 Oe=79.6 A/m) was applied to each MR element in the direction perpendicular to the medium facing surface 40 and the relationship between the applied magnetic field H and the output voltage V of the MR element was obtained. Here, the difference between the maximum value and the minimum value (peak-to-peak value) of the output voltage V when the above-mentioned alternating magnetic field was applied to the MR element is defined as the output value Amp.

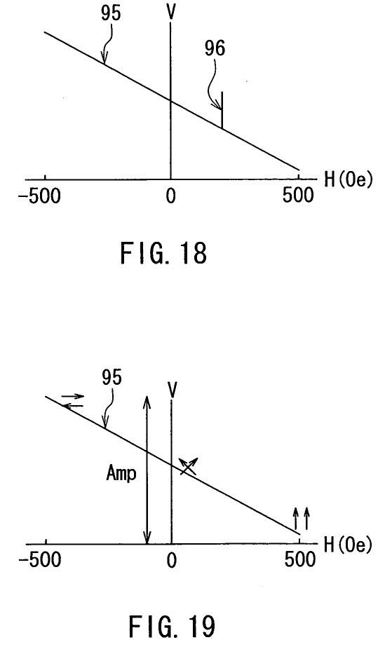

FIG. 18 shows the relationship between the applied magnetic field H and the output voltage V for one of the MR elements of Comparative Example. FIG. 19 shows the relationship between the applied magnetic field H and the output voltage V for one of the MR elements of Example. In each of FIG. 18 and FIG. 19, the straight line 95 shows the relationship between the applied magnetic field H and the output voltage V of the MR element. In FIG. 18 the straight lines 96 indicate that the output voltage V abruptly changed to greatly deviate from its ideal value (shown by the straight line 95) when the applied magnetic field H was of certain magnitude. In FIG. 19, the three pairs of arrows drawn near the straight line 95 indicate the directions of the magnetizations of the ferromagnetic layers 52 and 54.

In the experiment, an MR element that showed an abrupt change in output voltage as indicated by each straight line 96 of FIG. 18, the magnitude of the abrupt change (the magnitude of the change in voltage indicated with the length of the straight line 96 of FIG. 18) exceeding 10% of the output value Amp, was defined as a defective element. Then, the percentage of the defective elements in the 200 MR elements of Example and that in the 200 MR elements of Comparative Example were determined. The results showed that the percentage of the defective elements in the 200 MR elements of Example was 5%, whereas the percentage of the defective elements in the 200 MR elements of Comparative Example was 47%. This indicates that the MR elements of Example are capable of significantly suppressing the occurrence of abrupt changes in output voltage, compared with the MR elements of Comparative Example.

The reason why abrupt changes in output voltage occurred with high frequency in the MR elements of Comparative Example is presumably as follows. In the MR elements of Comparative Example, the closed-magnetic-path-forming portions 170 and 180 respectively include the long and narrow coupling portions 171 and 181 each extending in the direction perpendicular to the medium facing surface 40. Each of the coupling portions 171 and 181 has a magnetic shape anisotropy that orients the easy axis of magnetization to the direction perpendicular to the medium facing surface 40. In addition, each of the coupling portions 171 and 181 is prone to saturation of magnetic flux because of the small cross-sectional area of the magnetic path. Due to these factors, reversal of the magnetization direction tends to occur in part or the whole of the coupling portions 171 and 181 when a magnetic field varying in magnitude is applied in the direction perpendicular to the medium facing surface 40. The coupling portions 171 and 181 are thus presumably magnetically unstable against changes in magnitude of the magnetic field applied in the direction perpendicular to the medium facing surface 40. This is presumably why abrupt changes in output voltage occurred with high frequency in the MR elements of Comparative Example.

In contrast, in the MR elements of Example, the closed-magnetic-path-forming portions 72 and 82 do not include the long and narrow coupling portions 171 and 181 extending in the direction perpendicular to the medium facing surface 40, but include the magnetic-path-expanding portions 76 and 86 instead. The magnetic-path-expanding portions 76 and 86 are smaller in magnetic shape anisotropy than the coupling portions 171 and 181. Furthermore, the magnetic-path-expanding portions 76 and 86 are less prone to saturation of magnetic flux than the coupling portions 171 and 181, because of the larger cross-sectional area of the magnetic path. As a result of the foregoing, in the MR elements of Example, the magnetic-path-expanding portions 76 and 86 are stable against changes in magnitude of the magnetic field applied in the direction perpendicular to the medium facing surface 40. This is presumably why the MR elements of Example showed significant suppression of abrupt changes in output voltage.

The experimental results described above indicate that the present embodiment makes it possible to suppress the occurrence of abrupt changes in output of the MR element.

In the present embodiment, the first and second portions 74 and 75 and the magnetic-path-expanding portion 76 are stacked with the separating layer 73 provided between the magnetic-path-expanding portion 76 and each of the first and second portions 74 and 75. The first and second portions 84 and 85 and the magnetic-path-expanding portion 86 are stacked with the separating layer 83 provided between the magnetic-path-expanding portion 86 and each of the first and second portions 84 and 85. This increases the flexibility of arrangement of the magnetic-path-expanding portions 76 and 86 and makes it easier to provide the magnetic-path-expanding portions 76 and 86, compared with a case where the first and second portions 74 and 75 and the magnetic-path-expanding portion 76 are disposed in the same plane while the first and second portions 84 and 85 and the magnetic-path-expanding portion 86 are disposed in the same plane.

A head assembly and a magnetic disk drive of the present embodiment will now be described. Reference is now made to FIG. 21 to describe the head assembly of the present embodiment. The head assembly of the present embodiment includes the slider 210 shown in FIG. 20 and a supporter that flexibly supports the slider 210. Forms of this head assembly include a head gimbal assembly and a head arm assembly described below.

The head gimbal assembly 220 will be first described. The head gimbal assembly 220 has the slider 210 and a suspension 221 as the supporter that flexibly supports the slider 210. The suspension 221 has: a plate-spring-shaped load beam 222 formed of stainless steel, for example; a flexure 223 to which the slider 210 is joined, the flexure 223 being located at an end of the load beam 222 and giving an appropriate degree of freedom to the slider 210; and a base plate 224 located at the other end of the load beam 222. The base plate 224 is attached to an arm 230 of an actuator for moving the slider 210 along the x direction across the tracks of a magnetic disk platter 262. The actuator has the arm 230 and a voice coil motor that drives the arm 230. A gimbal section for maintaining the orientation of the slider 210 is provided in the portion of the flexure 223 on which the slider 210 is mounted.

The head gimbal assembly 220 is attached to the arm 230 of the actuator. An assembly including the arm 230 and the head gimbal assembly 220 attached to the arm 230 is called a head arm assembly. An assembly including a carriage having a plurality of arms with a plurality of head gimbal assemblies 220 respectively attached to the arms is called a head stack assembly.

FIG. 21 shows the head arm assembly of the present embodiment. In this head arm assembly, the head gimbal assembly 220 is attached to an end of the arm 230. A coil 231 that is part of the voice coil motor is fixed to the other end of the arm 230. A bearing 233 is provided in the middle of the arm 230. The bearing 233 is attached to a shaft 234 that rotatably supports the arm 230.

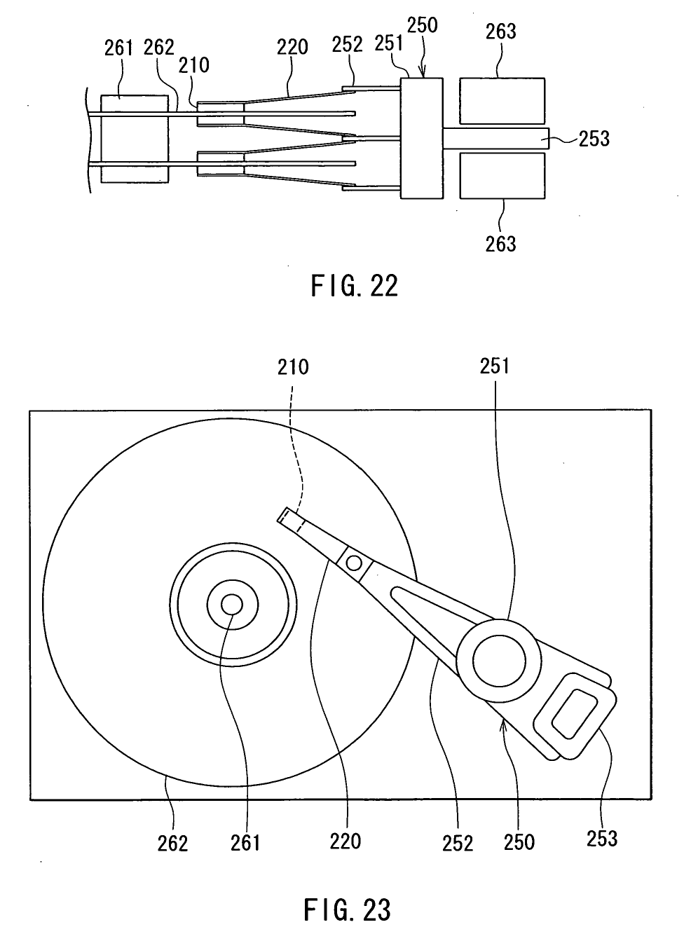

Reference is now made to FIG. 22 and FIG. 23 to describe an example of the head stack assembly and the magnetic disk drive of the present embodiment. FIG. 22 is an illustrative view showing a main part of the magnetic disk drive, and FIG. 23 is a plan view of the magnetic disk drive. The head stack assembly 250 includes a carriage 251 having a plurality of arms 252. A plurality of head gimbal assemblies 220 are attached to the arms 252 such that the assemblies 220 are aligned in the vertical direction with spacing between every adjacent ones. A coil 253 that is part of the voice coil motor is mounted on a side of the carriage 251 opposite to the arms 252. The head stack assembly 250 is installed in the magnetic disk drive. The magnetic disk drive includes a plurality of magnetic disk platters 262 mounted on a spindle motor 261. Two of the sliders 210 are allocated to each of the platters 262 such that the two sliders 210 are opposed to each other with a platter 262 disposed in between. The voice coil motor includes permanent magnets 263 disposed to be opposed to each other, the coil 253 of the head stack assembly 250 being placed between the magnets 263. The actuator and the head stack assembly 250 except the sliders 210 support the sliders 210 and align them with respect to the magnetic disk platters 262.

In the magnetic disk drive of the present embodiment, the actuator moves the slider 210 across the tracks of the magnetic disk platter 262 and aligns the slider 210 with respect to the magnetic disk platter 262. The thin-film magnetic head included in the slider 210 writes data on the magnetic disk platter 262 by using the write head, and reads data stored on the magnetic disk platter 262 by using the read head.

The head assembly and the magnetic disk drive of the present embodiment provide advantageous effects similar to those of the thin-film magnetic head of the embodiment described previously.

### Second Embodiment

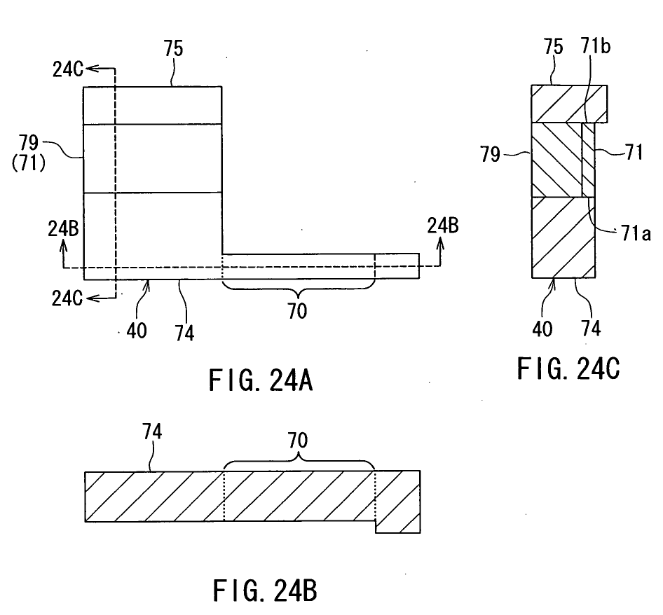

An MR element of a second embodiment of the invention will now be described. In the MR element of the second embodiment, the first and second read shield portions 3 and 8 have configurations different from those of the first embodiment. The configuration of the first read shield portion 3 of the second embodiment will now be described in detail with reference to FIG. 24A to FIG. 26C.

First, the first shield bias magnetic field applying layer 71, the first portion 74 and the second portion 75 will be described with reference to FIG. 24A to FIG. 24C. FIG. 24A is a plan view of a part of the first read shield portion 3. FIG. 24B is a cross-sectional view of the part of the first read shield portion 3 of FIG. 24A taken along line 24B-24B. FIG. 24C is a cross-sectional view of the part of the first read shield portion 3 of FIG. 24A taken along line 24C-24C. As shown in FIG. 24A, in the second embodiment, the second portion 75 of the first closed-magnetic-path-forming portion 72 has only a portion extending from the portion connected to the second end 71b of the first shield bias magnetic field applying layer 71 toward the direction away from the medium facing surface 40, and does not have any portion extending parallel to the track width direction (the horizontal direction in FIG. 24A). The bottom surface of the second portion 75 is located at a lower level than the bottom surface of the first shield bias magnetic field applying layer 71, thereby touching the top surface 76a of the first magnetic-path-expanding portion 76. The first shield bias magnetic field applying layer 71 and the first portion 74 of the second embodiment have the same shapes as those of the first embodiment.

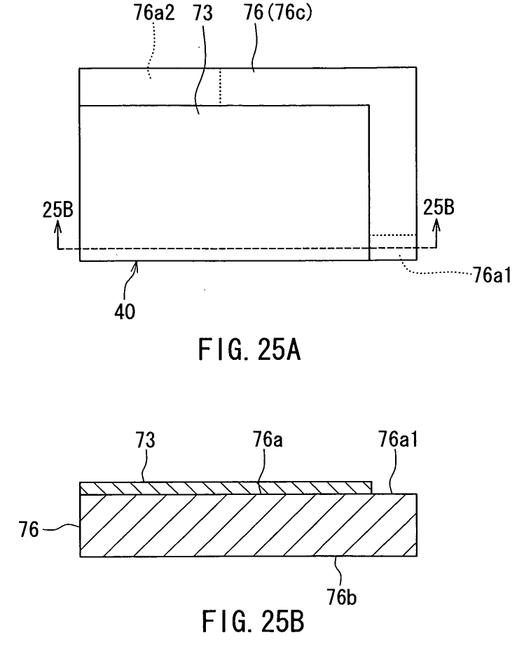

Reference is now made to FIG. 25A and FIG. 25B to describe the first magnetic-path-expanding portion 76 and the first separating layer 73. FIG. 25A is a plan view of the first magnetic-path-expanding portion 76 and the first separating layer 73. FIG. 25B is a cross-sectional view of the first magnetic-path-expanding portion 76 and the first separating layer 73 of FIG. 25A taken along line 25B-25B. The first magnetic-path-expanding portion 76 is rectangular-solid-shaped, and is formed of a magnetic layer having a top surface 76a and a bottom surface 76b that face toward opposite directions. The first separating layer 73 is disposed on the top surface 76a of the first magnetic-path-expanding portion 76 such that a portion of the top surface 76a is exposed. As shown in FIG. 25A, the first magnetic-path-expanding portion 76 has two end portions 76a1 and 76a2 located at both ends of the first magnetic path P11, and a middle portion 76c located between the two end portions. In the second embodiment, the two end portions 76a1 and 76a2 of the first magnetic-path-expanding portion 76 are included in the top surface 76a of the first magnetic-path-expanding portion 76. Specifically, the end portion 76a1 is a portion of the top surface 76a touching the first portion 74, and the end portion 76a2 is a portion of the top surface 76a touching the second portion 75. The middle portion 76c is a portion of the first magnetic-path-expanding portion 76 other than the two end portions 76a1 and 76a2.

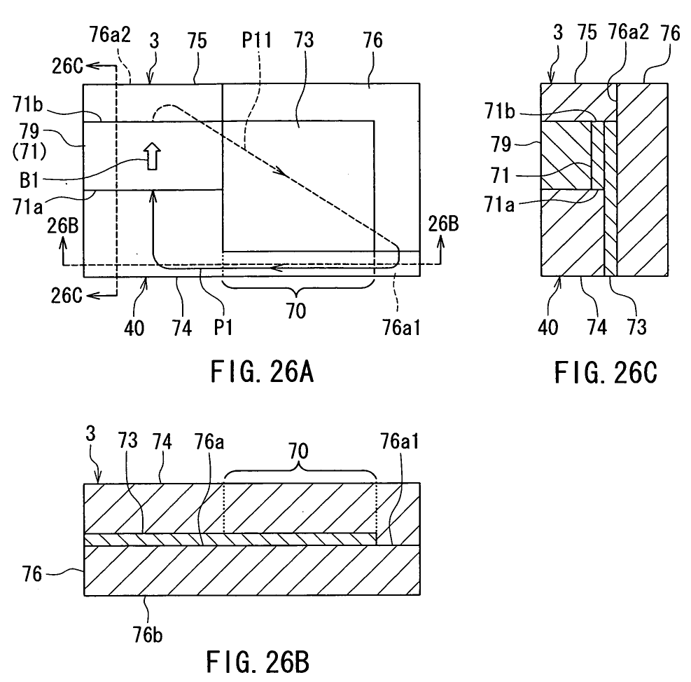

Reference is now made to FIG. 26A to FIG. 26C to describe the first read shield portion 3 as a whole. FIG. 26A is a plan view of the first read shield portion 3. FIG. 26B is a cross-sectional view of the first read shield portion 3 of FIG. 26A taken along line 26B-26B. FIG. 26C is a cross-sectional view of the first read shield portion 3 of FIG. 26A taken along line 26C-26C. The first read shield portion 3 is formed by providing the first shield bias magnetic field applying layer 71, the first portion 74, the second portion 75 and the nonmagnetic layer 79 shown in FIG. 24A to FIG. 24C on the first magnetic-path-expanding portion 76 and the first separating layer 73 shown in FIG. 25A and FIG. 25B. The end portion 76a1 of the first magnetic-path-expanding portion 76 is connected to the first portion 74 so that a magnetic path passing through the first single magnetic domain portion 70 is formed between the end portion 76a1 and the first end 71a of the first shield bias magnetic field applying layer 71. The end portion 76a2 of the first magnetic-path-expanding portion 76 is connected to the second portion 75. The first separating layer 73 is disposed between the top surface 76a of the first magnetic-path-expanding portion 76 except the two end portions 76a1 and 76a2 and each of the first and second portions 74 and 75, and magnetically separates the first and second portions 74 and 75 from the first magnetic-path-expanding portion 76 except the two end portions 76a1 and 76a2.

In FIG. 26A the first closed magnetic path P1 is shown as a line starting from the second end 71b of the first shield bias magnetic field applying layer 71 and terminating at the first end 71a of the first shield bias magnetic field applying layer 71. With reference to this line, the first closed magnetic path P1 is a magnetic path starting from the second end 71b of the first shield bias magnetic field applying layer 71, passing in succession through the second portion 75, the end portion 76a2 of the first magnetic-path-expanding portion 76, the middle portion 76c of the first magnetic-path-expanding portion 76, the end portion 76al of the first magnetic-path-expanding portion 76 and the first portion 74 (including the first single magnetic domain portion 70), and reaching the first end 71a of the first shield bias magnetic field applying layer 71.

As in the first embodiment, a cross section of the first magnetic path P11 at the middle portion 76c is greater in width than a cross section of the first magnetic path P11 at each of the two end portions 76a1 and 76a2, the width being taken in the direction parallel to the top surface 76a and the bottom surface 76b. The width of the cross section of the first magnetic path P11 at the end portion 76a1, as taken in the direction parallel to the top surface 76a and the bottom surface 76b, is approximately Wc. The width of the cross section of the first magnetic path P11 at the end portion 76a2, as taken in the direction parallel to the top surface 76a and the bottom surface 76b, is approximately Wb. The width of the cross section of the first magnetic path P11 at the middle portion 76c, as taken in the direction parallel to the top surface 76a and the bottom surface 76b, is approximately W2.

The remainder of configuration of the first read shield portion 3 is the same as that of the first embodiment. The second read shield portion 8 of the second embodiment has components similar to those of the first read shield portion 3. As in the first embodiment, relative positions of the components of the first read shield portion 3 and the components of the second read shield portion 8 are almost symmetrical with each other with respect to a line that passes through the vertical and horizontal center of the MR stack 5 and that is perpendicular to the medium facing surface 40. Thus, detailed descriptions of the second read shield portion 8 will be omitted.

In the second embodiment, as in the first embodiment, the closed-magnetic-path-forming portions 72 and 82 do not include the coupling portions 171 and 181 of the MR element of Comparative Example shown in FIG. 17. In the MR element of the first embodiment, the second portion 75 of the closed-magnetic-path-forming portion 72 and the second portion 85 of the closed-magnetic-path-forming portion 82 each include a long and narrow portion extending in the direction parallel to the medium facing surface 40. In contrast, in the second embodiment, each of the second portion 75 of the closed-magnetic-path-forming portion 72 and the second portion 85 of the closed-magnetic-path-forming portion 82 does not include any long and narrow portion extending in the direction parallel to the medium facing surface 40. Accordingly, in the MR element of the second embodiment, the closed-magnetic-path-forming portions 72 and 82 are stable against changes in magnitude of an applied magnetic field, irrespective of the direction of the applied magnetic field. As a result, the second embodiment allows greater suppression of the occurrence of abrupt changes in output of the MR element.

The remainder of configuration, functions and advantageous effects of the second embodiment are similar to those of the first embodiment.

### Third Embodiment

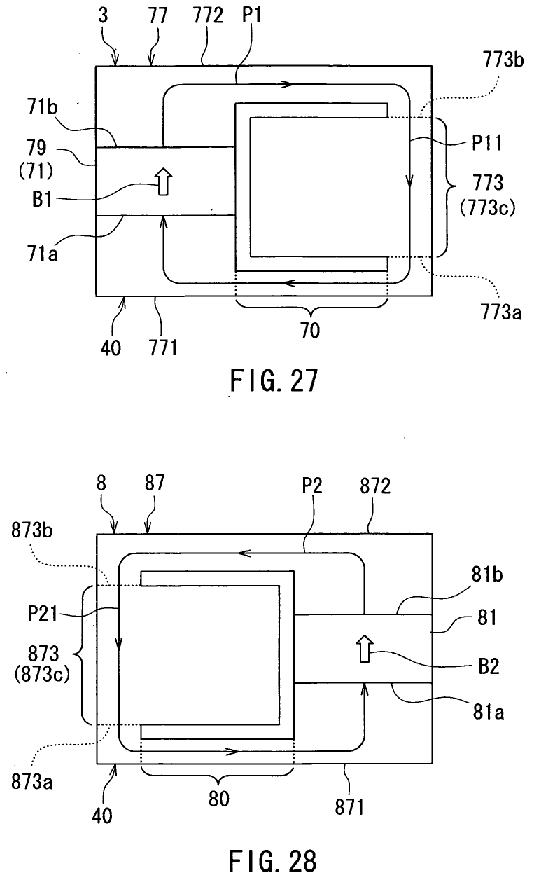

An MR element of a third embodiment of the invention will now be described with reference to FIG. 27 and FIG. 28. In the MR element of the third embodiment, the first and second read shield portions 3 and 8 have configurations different from those of the first embodiment. Specifically, in each of the first and second read shield portions 3 and 8 of the first embodiment, the first and second portions and the magnetic-path-expanding portion are stacked with the separating layer provided between the magnetic-path-expanding portion and each of the first and second portions, whereas in each of the first and second read shield portions 3 and 8 of the third embodiment, the first and second portions and the magnetic-path-expanding portion are formed of a single magnetic layer. FIG. 27 is a plan view of the first read shield portion 3 of the third embodiment. FIG. 28 is a plan view of the second read shield portion 8 of the third embodiment.

As shown in FIG. 27, the first read shield portion 3 of the third embodiment includes a first closed-magnetic-path-forming portion 77 formed of a single magnetic layer, instead of the first closed-magnetic-path-forming portion 72 of the first embodiment. The first closed-magnetic-path-forming portion 77 includes a first portion 771, a second portion 772, and a first magnetic-path-expanding portion 773. The first portion 771 includes a first single magnetic domain portion 70.

The first portion 771 is connected to the first end 71a of the first shield bias magnetic field applying layer 71. The first portion 771 initially extends from the portion connected to the first end 71a toward the medium facing surface 40, and then turns to extend parallel to the track width direction (the horizontal direction in FIG. 27) toward the right in FIG. 27, with an extremity portion protruding toward the direction away from the medium facing surface 40.

The second portion 772 is connected to the second end 71b of the first shield bias magnetic field applying layer 71. The second portion 772 initially extends from the portion connected to the second end 71b toward the direction away from the medium facing surface 40, and then turns to extend parallel to the track width direction (the horizontal direction in FIG. 27) toward the right in FIG. 27, with an extremity portion protruding toward the medium facing surface 40.

The first magnetic-path-expanding portion 773 is coupled to the extremity portion of the first portion 771 and the extremity portion of the second portion 772. The first magnetic-path-expanding portion 773 forms a first magnetic path P11 that is a portion of the first closed magnetic path P1 and located between the first shield bias magnetic field applying layer 71 and the first single magnetic domain portion 70. The first magnetic-path-expanding portion 773 has two end portions 773a and 773b located at both ends of the first magnetic path P11, and a middle portion 773c located between the two end portions. The end portion 773a is the portion coupled to the first portion 771, and the end portion 773b is the portion coupled to the second portion 772. The middle portion 773c is a portion of the first magnetic-path-expanding portion 773 other than the two end portions 773a and 773b. The width of the cross section of the first magnetic path P11 at each of the end portions 773a and 773b, as taken in the direction parallel to the top surface 76a and the bottom surface 76b, is equal to Wc shown in FIG. 5B. The middle portion 773c protrudes toward the first shield bias magnetic field applying layer 71 from the positions of the end portions 773a and 773b. Therefore, the cross section of the first magnetic path P11 at the middle portion 773c is greater in width than the cross section of the first magnetic path P11 at each of the end portions 773a and 773b, the width being taken in the direction parallel to the top surface 76a and the bottom surface 76b.

As shown in FIG. 28, the second read shield portion 8 has components similar to those of the first read shield portion 3. Specifically, the second read shield portion 8 includes a second closed-magnetic-path-forming portion 87 formed of a single magnetic layer, instead of the second closed-magnetic-path-forming portion 82 of the first embodiment. The second closed-magnetic-path-forming portion 87 includes a first portion 871, a second portion 872, and a second magnetic-path-expanding portion 873. The first portion 871 includes a second single magnetic domain portion 80. Relative positions of the components of the first read shield portion 3 and the components of the second read shield portion 8 are symmetrical with each other with respect to a line that passes through the vertical and horizontal center of the MR stack 5 and that is perpendicular to the medium facing surface 40. Thus, detailed descriptions of the second read shield portion 8 will be omitted.

In the third embodiment, the first closed-magnetic-path-forming portion 77 and the second closed-magnetic-path-forming portion 88 include the first magnetic-path-expanding portion 773 and the second magnetic-path-expanding portion 873, respectively, and this allows the closed-magnetic-path-forming portions 77 and 87 to be stable against changes in magnitude of a magnetic field applied in the direction perpendicular to the medium facing surface 40. As a result, according to the third embodiment, it is possible to suppress the occurrence of abrupt changes in output of the MR element, like the first embodiment.

In the third embodiment, as in the second embodiment, each of the second portions 772 and 872 may be formed without the portion extending parallel to the track width direction, and the magnetic-path-expanding portions 773 and 873 may be coupled to the second portions 772 and 872, respectively. This makes the closed-magnetic-path-forming portions 77 and 87 stable against changes in magnitude of an applied magnetic field, irrespective of the direction of the applied magnetic field, as in the second embodiment, and thus allows greater suppression of the occurrence of abrupt changes in output of the MR element.

The remainder of configuration, functions and advantageous effects of the third embodiment are similar to those of the first embodiment.

The present invention is not limited to the foregoing embodiments but can be carried out in various modifications. For example, while each of the foregoing embodiments has shown an example in which the spacer layer is a tunnel barrier layer, the spacer layer of the present invention may be a nonmagnetic conductive layer, or may be a spacer layer of the current-confined-path type that includes a portion allowing the passage of currents and a portion intercepting the passage of currents.

While the foregoing embodiments have been described with reference to a thin-film magnetic head having a structure in which the read head is formed on the base body and the write head is stacked on the read head, the read head and the write head may be stacked in the reverse order. If the thin-film magnetic head is to be used only for read operations, the thin-film magnetic head may be configured to include the read head only.

The present invention is applicable not only to MR elements used as read heads of thin-film magnetic heads, but also to MR elements used for various purposes in general.

It is apparent that the present invention can be carried out in various forms and modifications in the light of the foregoing descriptions. Accordingly, within the scope of the following claims and equivalents thereof, the present invention can be carried out in forms other than the foregoing most preferable embodiments.

What is claimed is:

1. A magnetoresistive element comprising a first shield portion, a second shield portion, and an MR stack, wherein:
the first shield portion includes: a first shield bias magnetic field applying layer that generates a first shield bias magnetic field; and a first closed-magnetic-path-forming portion that forms a first closed magnetic path in conjunction with the first shield bias magnetic field applying layer, the first closed-magnetic-path-forming portion including a first single magnetic domain portion that is brought into a single magnetic domain state such that a magnetization thereof is directed to a first direction by a magnetic flux generated by the first shield bias magnetic field and passing through the first closed magnetic path;
the second shield portion includes: a second shield bias magnetic field applying layer that generates a second shield bias magnetic field; and a second closed-magnetic-path-forming portion that forms a second closed magnetic path in conjunction with the second shield bias magnetic field applying layer, the second closed-magnetic-path-forming portion including a second single magnetic domain portion that is brought into a single magnetic domain state such that a magnetization thereof is directed to a second direction by a magnetic flux generated by the second shield bias magnetic field and passing through the second closed magnetic path;
the first and second single magnetic domain portions and the MR stack are disposed such that the MR stack is sandwiched between the first and second single magnetic domain portions;
the MR stack includes: a first ferromagnetic layer magnetically coupled to the first single magnetic domain portion; a second ferromagnetic layer magnetically coupled to the second single magnetic domain portion; and a spacer layer made of a nonmagnetic material and disposed between the first and second ferromagnetic layers;
the first closed-magnetic-path-forming portion further includes a first magnetic-path-expanding portion that is formed of a magnetic layer having two surfaces facing toward opposite directions and that forms a first magnetic path, the first magnetic path being a portion of the first closed magnetic path and being located between the first shield bias magnetic field applying layer and the first single magnetic domain portion, the first magnetic-path-expanding portion having two end portions located at both ends of the first magnetic path, and a middle portion located between the two end portions, a cross section of the first magnetic path at the middle portion being greater in width than a cross section of the first magnetic path at each of the two end portions, the width being taken in a direction parallel to the two surfaces; and
the second closed-magnetic-path-forming portion further includes a second magnetic-path-expanding portion that is formed of a magnetic layer having two surfaces facing toward opposite directions and that forms a second magnetic path, the second magnetic path being a portion of the second closed magnetic path and being located between the second shield bias magnetic field applying layer and the second single magnetic domain portion, the second magnetic-path-expanding portion having two end portions located at both ends of the second magnetic path, and a middle portion located between the two end portions, a cross section of the second magnetic path at the middle portion being greater in width than a cross section of the second magnetic path at each of the two end portions, the width being taken in a direction parallel to the two surfaces.

2. The magnetoresistive element according to claim 1, wherein the first direction and the second direction are antiparallel to each other.

3. The magnetoresistive element according to claim 2, wherein the first and second shield bias magnetic field applying layers each have a magnetization directed to a third direction different from the first and second directions.

4. The magnetoresistive element according to claim 1, wherein:
the first shield bias magnetic field applying layer has a first end and a second end, and the first closed-magnetic-path-forming portion includes: a first portion that includes the first single magnetic domain portion and that is connected to the first end of the first shield bias magnetic field applying layer; and a second portion connected to the second end of the first shield bias magnetic field applying layer, one of the two end portions of the first magnetic-path-expanding portion being connected to the first portion of the first closed-magnetic-path-forming portion so that a magnetic path passing through the first single magnetic domain portion is formed between this one of the two end portions and the first end of the first shield bias magnetic field applying layer, the other of the two end portions of the first magnetic-path-expanding portion being connected to the second portion of the first closed-magnetic-path-forming portion; and
the second shield bias magnetic field applying layer has a first end and a second end, and the second closed-magnetic-path-forming portion includes: a first portion that includes the second single magnetic domain portion and that is connected to the first end of the second shield bias magnetic field applying layer; and a second portion connected to the second end of the second shield bias magnetic field applying layer, one of the two end portions of the second magnetic-path-expanding portion being connected to the first portion of the second closed-magnetic-path-forming portion so that a magnetic path passing through the second single magnetic domain portion is formed between this one of the two end portions and the first end of the second shield bias magnetic field applying layer, the other of the two end portions of the second magnetic-path-expanding portion being connected to the second portion of the second closed-magnetic-path-forming portion.

5. The magnetoresistive element according to claim 4, wherein:
the first magnetic-path-expanding portion is disposed to overlap the first and second portions of the first closed-magnetic-path-forming portion as seen in a direction perpendicular to the two surfaces of the first magnetic-path-expanding portion, and the two end portions of the first magnetic-path-expanding portion are included in one of the two surfaces, the first shield portion further including a first separating layer that magnetically separates the first and second portions of the first closed-magnetic-path-forming portion from the first magnetic-path-expanding portion except the two end portions; and
the second magnetic-path-expanding portion is disposed to overlap the first and second portions of the second closed-magnetic-path-forming portion as seen in a direction perpendicular to the two surfaces of the second magnetic-path-expanding portion, and the two end portions of the second magnetic-path-expanding portion are included in one of the two surfaces, the second shield portion further including a second separating layer that magnetically separates the first and second portions of the second closed-magnetic-path-forming portion from the second magnetic-path-expanding portion except the two end portions.

6. The magnetoresistive element according to claim 1, wherein the MR stack further includes: a first coupling layer disposed between the first single magnetic domain portion and the first ferromagnetic layer and magnetically coupling the first ferromagnetic layer to the first single magnetic domain portion; and a second coupling layer disposed between the second single magnetic domain portion and the second ferromagnetic layer and magnetically coupling the second ferromagnetic layer to the second single magnetic domain portion.

7. The magnetoresistive element according to claim 6, wherein each of the first and second coupling layers includes a nonmagnetic conductive layer.

8. The magnetoresistive element according to claim 6, wherein at least one of the first and second coupling layers includes a magnetic layer, and two nonmagnetic conductive layers sandwiching the magnetic layer.

9. The magnetoresistive element according to claim 1, further comprising a bias magnetic field applying layer disposed between the first and second shield portions so as to be adjacent to the MR stack in a direction orthogonal to a direction in which the layers constituting the MR stack are stacked, the bias magnetic field applying layer applying a bias magnetic field to the first and second ferromagnetic layers so that magnetizations of the first and second ferromagnetic layers change their directions compared with a state in which no bias magnetic field is applied to the first and second ferromagnetic layers.

10. The magnetoresistive element according to claim 9, wherein the bias magnetic field applying layer applies the bias magnetic field to the first and second ferromagnetic layers so that the magnetizations of the first and second ferromagnetic layers are directed orthogonal to each other.

11. The magnetoresistive element according to claim 10, wherein the bias magnetic field applying layer and the first and second shield bias magnetic field applying layers have magnetizations directed to the same direction.

12. A thin-film magnetic head comprising: a medium facing surface that faces toward a recording medium; and the magnetoresistive element according to claim 1, the magnetoresistive element being disposed near the medium facing surface to detect a signal magnetic field sent from the recording medium.

13. A head assembly comprising: a slider including a thin-film magnetic head and disposed to face toward a recording medium; and a supporter flexibly supporting the slider, the thin-film magnetic head comprising: a medium facing surface that faces toward the recording medium; and the magnetoresistive element according to claim 1, the magnetoresistive element being disposed near the medium facing surface to detect a signal magnetic field sent from the recording medium.

14. A magnetic disk drive comprising: a slider including a thin-film magnetic head and disposed to face toward a recording medium that is driven to rotate; and an alignment device supporting the slider and aligning the slider with respect to the recording medium,
the thin-film magnetic head comprising: a medium facing surface that faces toward the recording medium; and the magnetoresistive element according to claim 1, the magnetoresistive element being disposed near the medium facing surface to detect a signal magnetic field sent from the recording medium.
